(19) United States
(12) Patent Application Publication
(10) Pub. No.: US 2026/0172205 A1
(43) Pub. Date: Jun. 18, 2026

(54) MANAGEMENT AND CONTROL APPARATUS, COMMUNICATION SYSTEM AND CONTROL METHOD

(71) Applicant: NTT, Inc., Tokyo (JP)

(72) Inventors: Karin UMEDA, Musashino-shi (JP); Kenji MIYAMOTO, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/129,587

(22) PCT Filed: Nov. 16, 2022
(86) PCT No.: PCT/JP2022/042569

§ 371 Date: May 13, 2025

(51) Int. Cl. H04L 5/00

(52) U.S. Cl. CPC H04L 5/0057

(57) ABSTRACT

A management control device includes: a cooperation information collection unit configured to acquire, at a predetermined period, cooperation information indicating a state of communication with one or more terminals from one or more base stations that perform wireless communication with the one or more terminals; an analysis unit configured to determine whether switching of an optical path is necessary based on the cooperation information; an optical path switching control unit configured to transmit switching destination information including information on a destination of optical path switching to a transfer device that switches the optical path connected to the one or more base stations when it is determined that switching of the optical path is necessary, and instruct a base station that is a source of the optical path switching to change a connection of a terminal associated with switching of the optical path; and a sleep control unit configured to transition the base station that is the source of the optical path switching to a sleep state after the optical path is switched and the connection of the terminal is changed.

### TECHNICAL FIELD

The present invention relates to a management control device, a communication system, and a control method.

### BACKGROUND ART

In a conventional communication system in which wireless communication is performed between a terminal and base stations, the management control device receives cooperation information and performs optical path switching and sleep control based on the received cooperation information.

### CITATION LIST

### Non Patent Literature

Non Patent Literature 1: “Cisco's vision of end-to-end architecture for the 5G era”, Cisco, 2020.

Non Patent Literature 2: “3GPP TS 38.300V 16.5.0 ”, 3GPP, 2021.

Non Patent Literature 3: “3GPP TS 38.401V 17.1.1 ”, 3GPP, 2022.

### SUMMARY OF INVENTION

### Technical Problem

However, in conventional communication systems, when performing sleep control, it is necessary to switch the optical path of the base station and change the connection of the terminal. However, if the timing of the optical path switching and the terminal connection change processing do not match, the exchange of information that should be performed by the connection change is blocked by the optical path switching. As a result, there is a problem that the terminal connection change processing is not completed, and there is a time when signals cannot be transferred between base stations, resulting in packet loss and delay.

In view of the above circumstances, an object of the present invention is to provide a technology that can suppress packet loss and delay.

### Solution to Problem

An aspect of the present invention provides a management control device including: a cooperation information collection unit configured to acquire, at a predetermined period, cooperation information indicating a state of communication with one or more terminals from one or more base stations that perform wireless communication with the one or more terminals; an analysis unit configured to determine whether switching of an optical path is necessary based on the cooperation information; an optical path switching control unit configured to transmit switching destination information including information on a destination of optical path switching to a transfer device that switches the optical path connected to the one or more base stations when it is determined that switching of the optical path is necessary, and instruct a base station that is a source of the optical path switching to change a connection of a terminal associated with switching of the optical path; and a sleep control unit configured to transition the base station that is the source of the optical path switching to a sleep state after the optical path is switched and the connection of the terminal is changed.

An aspect of the present invention provides a communication system including: a cooperation information collection unit configured to acquire, at a predetermined period, cooperation information indicating a state of communication with one or more terminals from one or more base stations that perform wireless communication with the one or more terminals; an analysis unit configured to determine whether switching of an optical path is necessary based on the cooperation information; an optical path switching control unit configured to transmit switching destination information including information on a destination of optical path switching to a transfer device that switches the optical path connected to the one or more base stations when it is determined that switching of the optical path is necessary, and instruct a base station that is a source of the optical path switching to change a connection of a terminal associated with switching of the optical path; and a sleep control unit configured to transition the base station that is the source of the optical path switching to a sleep state after the optical path is switched and the connection of the terminal is changed.

An aspect of the present invention provides a control method including: acquiring, at a predetermined period, cooperation information indicating a state of communication with one or more terminals from one or more base stations that perform wireless communication with the one or more terminals; determining whether switching of an optical path is necessary based on the cooperation information; transmitting switching destination information including information on a destination of optical path switching to a transfer device that switches the optical path connected to the one or more base stations when it is determined that switching of the optical path is necessary; instructing a base station that is a source of the optical path switching to change a connection of a terminal associated with switching of the optical path; and transitioning the base station that is the source of the optical path switching to a sleep state after the optical path is switched and the connection of the terminal is changed.

### Advantageous Effects of Invention

According to the present invention, it is possible to suppress packet loss and delay.

### BRIEF DESCRIPTION OF DRAWINGS

FIG. 1 A diagram for explaining an outline of the processing of a mobile NW system in a first embodiment.

FIG. 2 A diagram showing a configuration example of the mobile NW system in the first embodiment.

FIG. 3 A sequence diagram showing an example of a detailed flow of sleep processing executed by the mobile NW system in the first embodiment.

FIG. 4 A sequence diagram showing an example of a detailed flow of sleep processing executed by a mobile NW system in the first embodiment.

FIG. 5 A sequence diagram showing an example of a detailed flow of sleep cancellation processing executed by the mobile NW system in the first embodiment.

FIG. 6 A sequence diagram showing an example of a detailed flow of sleep cancellation processing executed by the mobile NW system in the first embodiment.

FIG. 7 A diagram showing a configuration example of a mobile NW system in a first modification example of the first embodiment.

FIG. 8 A diagram showing a configuration example of a mobile NW system in a second modification example of the first embodiment.

FIG. 9 A diagram showing a configuration example of a mobile NW system in a third modification example of the first embodiment.

FIG. 10 A sequence diagram showing an example of a detailed flow of sleep processing executed by the mobile NW system in the third modification example of the first embodiment.

FIG. 11 A sequence diagram showing an example of a detailed flow of sleep processing executed by the mobile NW system in the third modification example of the first embodiment.

FIG. 12 A sequence diagram showing an example of a detailed flow of sleep cancellation processing executed by the mobile NW system in the third modification example of the first embodiment.

FIG. 13 A sequence diagram showing an example of a detailed flow of sleep cancellation processing executed by the mobile NW system in the third modification example of the first embodiment.

FIG. 14 A diagram for explaining an outline of the processing of a mobile NW system in a second embodiment.

FIG. 15 A diagram showing a configuration example of the mobile NW system in the second embodiment.

FIG. 16 A sequence diagram showing an example of a detailed flow of sleep processing executed by the mobile NW system in the second embodiment.

FIG. 17 A sequence diagram showing an example of a detailed flow of the sleep processing executed by the mobile NW system in the second embodiment.

FIG. 18 A sequence diagram showing an example of a detailed flow of sleep cancellation processing executed by the mobile NW system in the second embodiment.

FIG. 19 A sequence diagram showing an example of a detailed flow of the sleep cancellation processing executed by the mobile NW system in the second embodiment.

FIG. 20 A sequence diagram showing an example of a detailed flow of the sleep processing executed by a mobile NW system in a second modification example of the second embodiment.

FIG. 21 A sequence diagram showing an example of a detailed flow of the sleep processing executed by the mobile NW system in the second modification example of the second embodiment.

FIG. 22 A sequence diagram showing an example of a detailed flow of the sleep cancellation processing executed by a mobile NW system in a third modification example of the second embodiment.

FIG. 23 A sequence diagram showing an example of a detailed flow of sleep cancellation processing executed by the mobile NW system in the third modification example of the second embodiment.

FIG. 24 A diagram for explaining an outline of the processing of a mobile NW system in a third embodiment.

FIG. 25 A diagram showing a configuration example of the mobile NW system in the third embodiment.

FIG. 26 A sequence diagram showing an example of a detailed flow of sleep processing executed by the mobile NW system in the third embodiment.

FIG. 27 A sequence diagram showing an example of a detailed flow of sleep processing executed by the mobile NW system in the third embodiment.

FIG. 28 A sequence diagram showing an example of a detailed flow of sleep cancellation processing executed by the mobile NW system in the third embodiment.

FIG. 29 A sequence diagram showing an example of a detailed flow of sleep cancellation processing executed by the mobile NW system in the third embodiment.

FIG. 30 A sequence diagram showing an example of a detailed flow of sleep processing executed by a mobile NW system in a second modification example of the third embodiment.

FIG. 31 A sequence diagram showing an example of a detailed flow of sleep processing executed by the mobile NW system in the second modification example of the third embodiment.

FIG. 32 A sequence diagram showing an example of a detailed flow of sleep cancellation processing executed by a mobile NW system in a third modification example of the third embodiment.

FIG. 33 A sequence diagram showing an example of a detailed flow of sleep cancellation processing executed by a mobile NW system in a third modification example of the third embodiment.

### DESCRIPTION OF EMBODIMENTS

Hereinafter, an embodiment of the present invention will be described with reference to the accompanying drawings.

### Outline of First Embodiment

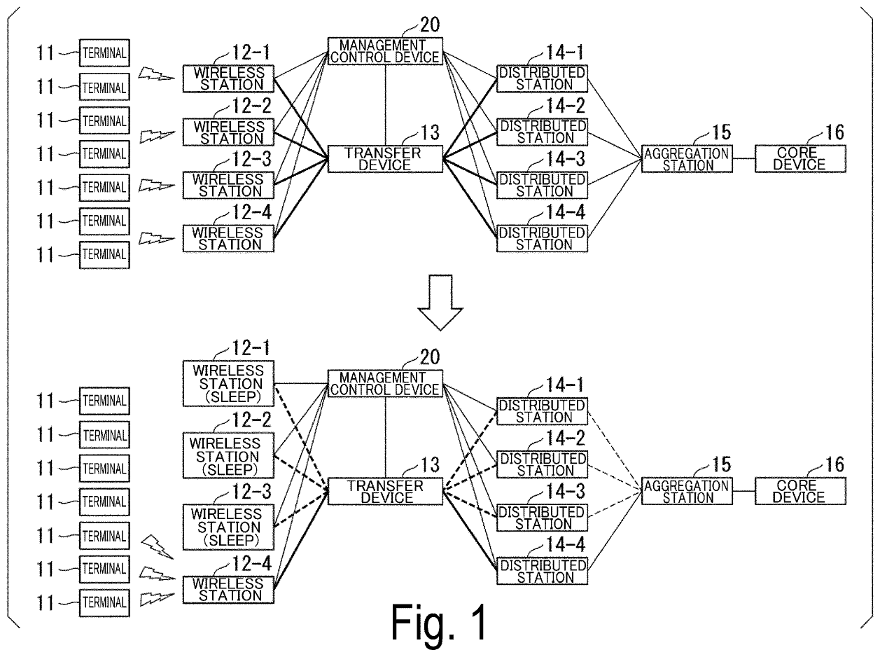

FIG. 1 is a diagram for explaining an outline of the processing of a mobile NW system in a first embodiment. First, the overall configuration of the mobile NW system in the first embodiment will be described. The mobile NW system in the first embodiment is an example of a communication system. The mobile NW system in the first embodiment is, for example, a fifth-generation mobile communication system (hereinafter referred to as “5G”). The mobile NW system in the first embodiment includes a plurality of wireless stations 12, a transfer device 13, a plurality of distributed stations 14, an aggregation station 15, a core device 16, and a management control device 20.

The wireless station 12 and the transfer device 13, the transfer device 13 and the distributed station 14, the distributed station 14 and the aggregation station 15, and the aggregation station 15 and the core device 16 are connected by optical fibers that transmit optical signals. The transfer device 13 and the management control device 20, and the distributed station 14 and the management control device 20 are connected by electric wires or optical fibers that transmit electric signals. In the example shown in FIG. 1, four wireless stations 12 and four distributed stations 14 are shown. Note that a plurality of transfer devices 13 may be provided, but the following description will be given with an example of one transfer device.

The wireless station 12 has one or more antennas and performs wireless communication with the terminal 11. For example, the wireless station 12 receives a signal transmitted from the terminal 11 and transmits the received signal to the distributed station 14 connected via the transfer device 13. The wireless station 12 transmits the signal received via the transfer device 13 to the terminal 11. The wireless station 12 is, for example, a RU (Radio Unit) in the 5G communication standard.

The wireless station 12 receives an optical path switching instruction, an instruction to change connection of the terminal 11, and a sleep instruction from the management control device 20. The wireless station 12 switches the optical path and changes the connection of the terminal 11 according to the received optical path switching instruction and the instruction to change the connection of the terminal 11. The optical path is the path of an optical signal. When the wireless station 12 receives the optical path switching instruction and the instruction to change the connection of the terminal 11, the wireless station 12 requests the aggregation station 15 to switch the connection and change the connection of the terminal 11. Furthermore, the wireless station 12 transitions to a sleep state according to the received sleep instruction. The sleep state is a state in which power can be saved by partially stopping or entirely stopping the base station.

The transfer device 13 is provided between the wireless station 12 and the distributed station 14. The transfer device 13 switches the optical path according to an instruction (hereinafter referred to as “switching destination information”) indicating the destination of the optical path switching transmitted from the management control device 20. For example, the transfer device 13 switches the connection between the wireless station 12 and the distributed station 14 by switching the optical path to the switching destination indicated by the switching destination information. When switching the optical path, the transfer device 13 issues an optical path switching start instruction to the wireless station 12 and the distributed station 14, which are the switching sources.

The distributed station 14 receives an uplink signal transmitted by the wireless station 12 via the transfer device 13. The distributed station 14 transmits a downlink signal to the wireless station 12 via the transfer device 13. Note that an uplink signal is a signal transmitted by the terminal 11, and a downlink signal is a signal addressed to the terminal 11. The distributed station 14 receives an optical path switching instruction and a sleep instruction from the management control device 20. The distributed station 14 switches the optical path according to the received optical path switching instruction. The distributed station 14 transitions to a sleep state according to the received sleep instruction. The distributed station 14 is, for example, a DU (Distributed Unit) in the 5G communication standard. Information acquired by the management control device 20 from the distributed station 14 will be referred to as cooperation information. The cooperation information is information indicating the state of communication between each distributed station 14 and the terminal 11.

The cooperation information in the first embodiment includes, for example, information on the traffic volume of each distributed station. Hereinafter, the information on the traffic volume is referred to as traffic information.

The aggregation station 15 aggregates the uplink signals transmitted by each distributed station 14. The aggregation station 15 distributes the downlink signals to each aggregation station 15. The aggregation station 15 is, for example, a CU (Centralized Unit) in the 5G communication standard. When the aggregation station 15 receives an instruction to switch the connection of the terminal 11 from the distributed station 14, the aggregation station 15 transmits information about the terminal 11 to the distributed station 14 that transmitted the instruction to switch the connection of the terminal 11, and performs processing related to the connection change of the terminal 11. The aggregation station 15 transmits a connection change completion notification to the management control device 20.

When a new terminal is connected to the sleep target wireless station 12 and distributed station 14 or the connection of the terminal 11 is changed from another base station, the aggregation station 15 may instruct the source wireless station 12 and distributed station 14 to reject the new terminal connection after receiving a switching instruction from the source wireless station 12 and distributed station 14.

The core device 16 executes signal processing on the uplink signals aggregated by the aggregation station 15. The core device 16 transmits a signal obtained as a result of the execution of the signal processing on the uplink signals to an external network. The core device 16 receives signals from the external network.

The core device 16 performs predetermined signal processing on the signals received from the external network. The core device 16 transmits a signal obtained as a result of executing signal processing on the signals received from the external network to the aggregation station 15 as a downlink signal. The signal processing is, for example, transfer of user data in a UPF (User Plane Function) of a 5G core network.

The management control device 20 is a device that manages the entire mobile NW system 100. The management control device 20 acquires cooperation information from each distributed station 14. The management control device 20 determines whether optical path switching and sleep control are necessary based on the acquired cooperation information. When it is determined that optical path switching and sleep control are necessary, the management control device 20 performs optical path switching control processing and sleep control processing. The optical path switching control processing is processing of switching an optical path between the wireless station 12 and the distributed station 14. For example, the management control device 20 transmits switching destination information to the transfer device 13 and transmits an optical path switching instruction and a terminal connection change instruction to the device (for example, the wireless station 12 and the distributed station 14) that is the source of the optical path switching. The sleep control processing is processing of executing or canceling sleep for each wireless station 12 and each distributed station 14.

Next, an outline of the processing of the mobile NW system will be described. The upper diagram of FIG. 1 shows the connection state of the mobile NW system before optical path switching, and the lower diagram of FIG. 1 shows the connection state of the mobile NW system after optical path switching. The upper diagram of FIG. 1 shows an example in which the wireless stations 12-1 to 12-4 and the distributed stations 14-1 to 14-4 are connected one-to-one, respectively. For example, the wireless station 12-1 is connected to the distributed station 14-1 via the transfer device 13, the wireless station 12-2 is connected to the distributed station 14-2 via the transfer device 13, the wireless station 12-3 is connected to the distributed station 14-3 via the transfer device 13, and the wireless station 12-4 is connected to the distributed station 14-4 via the transfer device 13.

The management control device 20 determines whether to perform optical path switching control processing based on the cooperation information collected from each distributed station 14. The management control device 20 compares a switching determination threshold stored in advance with the traffic volume indicated by the traffic information included in the collected cooperation information. The switching determination threshold is a threshold for determining that optical path switching is necessary. When the management control device 20 determines to perform optical path switching control processing, the management control device 20 transmits switching destination information to the transfer device 13. Furthermore, the management control device 20 transmits an optical path switching instruction to the distributed station 14 to be subjected to optical path switching and the wireless station 12 connected to the distributed station 14.

For example, it is assumed that the management control device 20 selects the distributed stations 14-1 to 14-3 to be subjected to optical path switching. In this case, the management control device 20 transmits an optical path switching instruction to the distributed stations 14-1 to 14-3 and the wireless stations 12-1 to 12-3 respectively connected to the distributed stations 14-1 to 14-3. According to the optical path switching instruction transmitted from the management control device 20, the distributed stations 14-1 to 14-3 and the wireless stations 12-1 to 12-3 request the aggregation station 15 to change the connection of the terminal 11 associated with the switching of the optical path. The aggregation station 15 performs processing of changing the connection of the terminal 11 for the distributed stations 14-1 to 14-3 in response to the request transmitted from the distributed stations 14-1 to 14-3 and the wireless stations 12-1 to 12-3.

The distributed stations 14-1 to 14-3 transmit an RRC (Radio Resource Control) reconfiguration instruction to the terminal 11. When the terminal 11 receives an RRC reconfiguration instruction from the connected distributed stations 14-1 to 14-3, the terminal 11 performs processing according to the RRC reconfiguration instruction and changes the connection. When the processing by the source distributed stations 14-1 to 14-3 is completed, the transfer device 13 switches the optical path. After completing the optical path switching, the transfer device 13 notifies the management control device 20 of the completion of the optical path switching.

When the management control device 20 receives the optical path switching completion notification from the transfer device 13, the management control device 20 transmits a sleep admission notification to the source distributed stations 14-1 to 14-3 and the source wireless stations 12-1 to 12-3. The sleep admission notification is a signal including an instruction to transition to a sleep state. As a result, the source distributed stations 14-1 to 14-3 and the source wireless stations 12-1 to 12-3 transition to a sleep state.

The lower diagram in FIG. 1 shows an example in which the terminal 11 connected to the distributed stations 14-1 to 14-3 connects to the wireless station 12-4, and the source distributed stations 14-1 to 14-3 and the source wireless stations 12-1 to 12-3 transition to a sleep state. In this way, in the mobile NW system of the first embodiment, after the connection change of the terminal 11 is completed, the optical path between the wireless station 12 and the distributed station 14 is switched. Hereinafter, the wireless station 12 and the distributed station 14 that transition to the sleep state are referred to as a source wireless station and a source distributed station, and the wireless station 12 and the distributed station 14 that will become a new connection destination are referred to as a destination wireless station and a destination distributed station.

### Details of First Embodiment

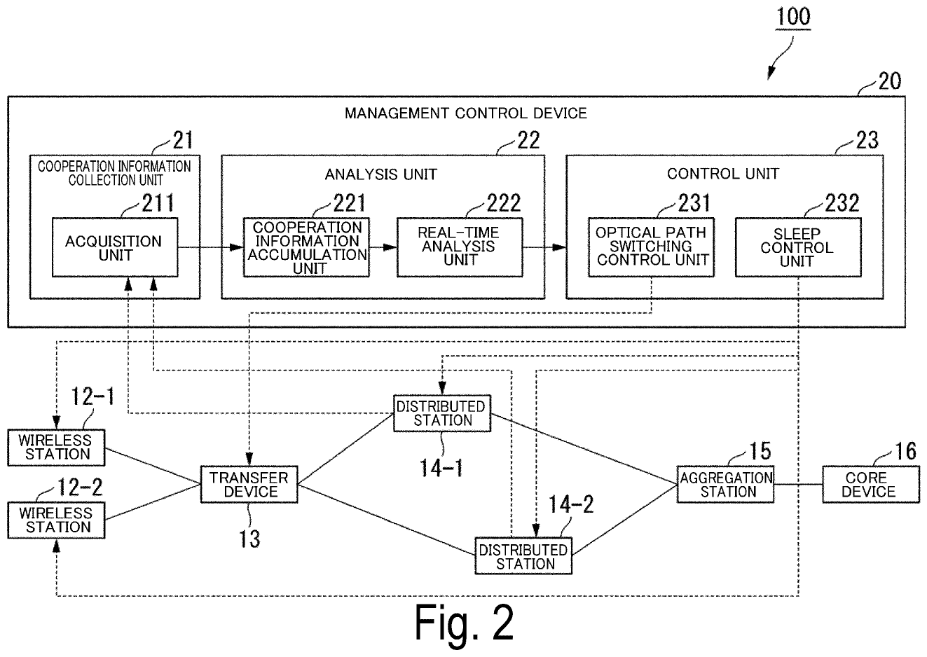

FIG. 2 is a diagram showing a configuration example of the mobile NW system 100 in the first embodiment. The mobile NW system 100 in the first embodiment includes a plurality of wireless stations 12, a transfer device 13, a plurality of distributed stations 14, an aggregation station 15, a core device 16, and a management control device 20. The wireless stations 12 and the distributed stations 14 are one aspect of a base station. Note that the wireless stations 12, the transfer device 13, the distributed stations 14, the aggregation station 15, and the core device 16 have been described in FIG. 1, so their description will be omitted. The management control device 20 includes a cooperation information collection unit 21, an analysis unit 22, and a control unit 23.

The cooperation information collection unit 21 includes an acquisition unit 211. The acquisition unit 211 collects cooperation information from the distributed stations 14 at a predetermined period.

The analysis unit 22 includes a cooperation information accumulation unit 221 and a real-time analysis unit 222. The cooperation information accumulation unit 221 records the collected cooperation information in a predetermined storage device. The real-time analysis unit 222 analyzes the state of communication between each distributed station 14 and the terminal 11 based on the cooperation information. Specifically, the real-time analysis unit 222 determines whether optical path switching and sleep control are necessary based on the cooperation information.

When determining whether optical path switching and sleep control are necessary, the real-time analysis unit 222 compares a switching determination threshold stored in advance with the traffic volume indicated by the traffic information included in the collected cooperation information. The real-time analysis unit 222 stores a switching determination threshold for each distributed station 14. The switching determination threshold is a threshold for determining whether optical path switching is necessary. In the first embodiment, when the volume of traffic flowing through the distributed station 14-2 is small, the distributed station 14-2 and the wireless station 12-2 connected to the distributed station 14-2 transition to a sleep state, and the optical path between the distributed station 14-2 and the wireless station 12-2 is switched to the optical path between the distributed station 14-1 and the wireless station 12-1. In this way, it is possible to reduce power consumption in the distributed station 14-2 through which the volume of traffic flowing is small, and in the wireless station 12-2 connected to the distributed station 14-2. In the following description, the distributed station 14-1 may be referred to as a destination distributed station 14-1, and the distributed station 14-2 may be referred to as a source distributed station 14-2.

For the above purpose, it is desirable to set the switching determination threshold to a value that is a criterion indicating that the volume of traffic is large. When the switching determination threshold is greater than the volume of traffic in the source distributed station, the real-time analysis unit 222 determines to perform the switching control processing of the optical path. If the switching determination threshold is greater than the traffic volume of the source distributed station, it means that the volume of traffic flowing through the source distributed station is small. On the other hand, if the switching determination threshold is equal to or less than the traffic volume of the source distributed station, the management control device 20 determines not to perform the optical path switching control processing. If the switching determination threshold is equal to or less than the traffic volume of the real-time analysis unit 222, it means that the volume of traffic flowing through the source distributed station is large. Note that the switching determination threshold may be the same for all distributed stations 14, or may be different for only some of the distributed stations 14.

The real-time analysis unit 222 determines whether a first switching condition is satisfied as a result of the comparison. The first switching condition is a condition indicating that switching of the optical path between the wireless station 12 and the distributed station 14 (source distributed station) is necessary. The first switching condition is, for example, that the switching determination threshold for the source distributed station is greater than the traffic volume obtained from the source distributed station, and that the switching determination threshold for the destination distributed station is greater than the traffic volume obtained from the destination distributed station.

The real-time analysis unit 222 determines to perform the optical path switching control processing when the first switching condition is satisfied. On the other hand, the real-time analysis unit 222 determines not to perform the optical path switching control processing when the first switching condition is not satisfied. When the real-time analysis unit 222 determines to perform the optical path switching control processing, the real-time analysis unit 222 notifies the control unit 23 of control information including information indicating the source wireless station and the source distributed station, information indicating the destination wireless station and the destination distributed station, and information indicating the wireless station 12 and distributed station 14 to be subjected to sleep control.

Here, in the first embodiment, the distributed station that becomes the source of the optical path switching when the first switching condition is satisfied is, for example, the distributed station 14-2. In the first embodiment, the distributed station that becomes the destination of the optical path switching when the first switching condition is satisfied is, for example, the distributed station 14-1. In the first embodiment, the wireless station and distributed station to be subjected to sleep control when the first switching condition is satisfied are, for example, the distributed station 14-2 that is the source of optical path switching, and the wireless station 12-2 connected to the distributed station 14-2. In this way, the real-time analysis unit 222 aggregates traffic by switching the optical path of the distributed station 14-2, through which the volume of traffic flowing is small, to the distributed station 14-1, through which the volume of traffic flowing is small.

Furthermore, the real-time analysis unit 222 determines whether a first sleep cancellation condition is satisfied or not. The first sleep cancellation condition is a condition that indicates that the sleep of the sleeping wireless station 12 and distributed station 14 is canceled. The first sleep cancellation condition is, for example, that the traffic volume of the distributed station 14 that is the switching destination under the first switching condition is greater than the switching determination threshold for the distributed station 14 that is the switching destination. In this way, the first sleep cancellation condition is a condition for canceling the sleep state of the distributed station that is in the sleeping state when the traffic of the distributed station 14 that is the switching destination under the first switching condition increases.

The real-time analysis unit 222 determines to perform the optical path switching control processing when the first sleep cancellation condition is satisfied. On the other hand, the real-time analysis unit 222 determines not to perform the optical path switching control processing when the first sleep cancellation condition is not satisfied. When the real-time analysis unit 222 determines to perform the optical path switching control processing, the real-time analysis unit 222 notifies the control unit 23 of control information including information indicating the source wireless station and the source distributed station, information indicating the destination wireless station and the destination distributed station, and information indicating the wireless station 12 and distributed station 14 to be subjected to sleep control.

The control unit 23 includes an optical path switching control unit 231 and a sleep control unit 232. The optical path switching control unit 231 determines a destination wireless station and a destination distributed station based on the analysis result from the real-time analysis unit 222. The optical path switching control unit 231 transmits switching destination information including information indicating the determined wireless station 12 and distributed station 14 which are the destinations of the optical path switching to the transfer device 13. As a result, the optical path switching control unit 231 instructs the transfer device 13 to switch the optical path.

Furthermore, the optical path switching control unit 231 determines a source wireless station and a source distributed station based on the analysis result from the real-time analysis unit 222. The optical path switching control unit 231 transmits an optical path switching instruction and a terminal connection change instruction to the determined wireless station 12 and distributed station 14 that are the sources of optical path switching.

The sleep control unit 232 causes the wireless station 12 and distributed station 14 to be subjected to sleep control to execute sleep or cancel sleep based on the analysis result from the real-time analysis unit 222.

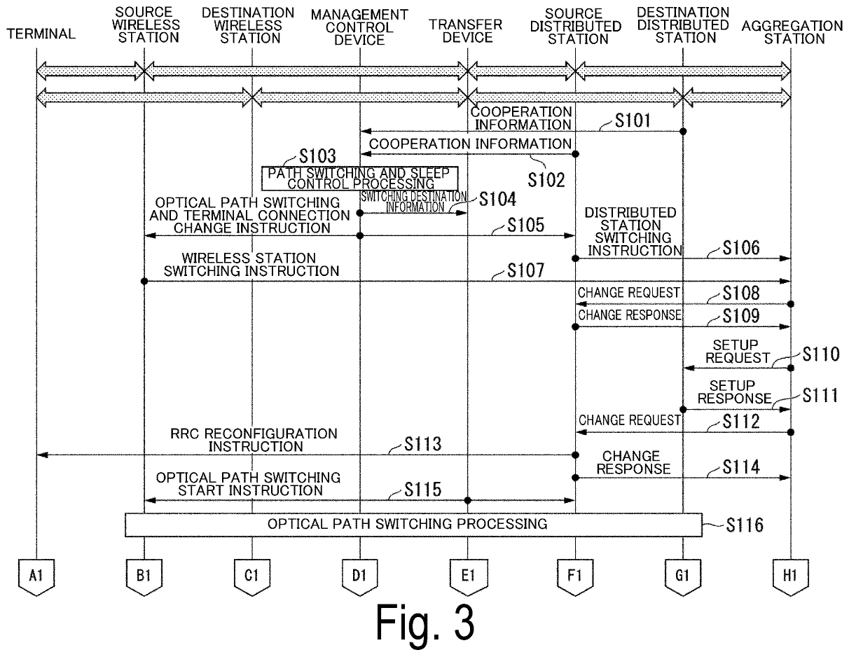

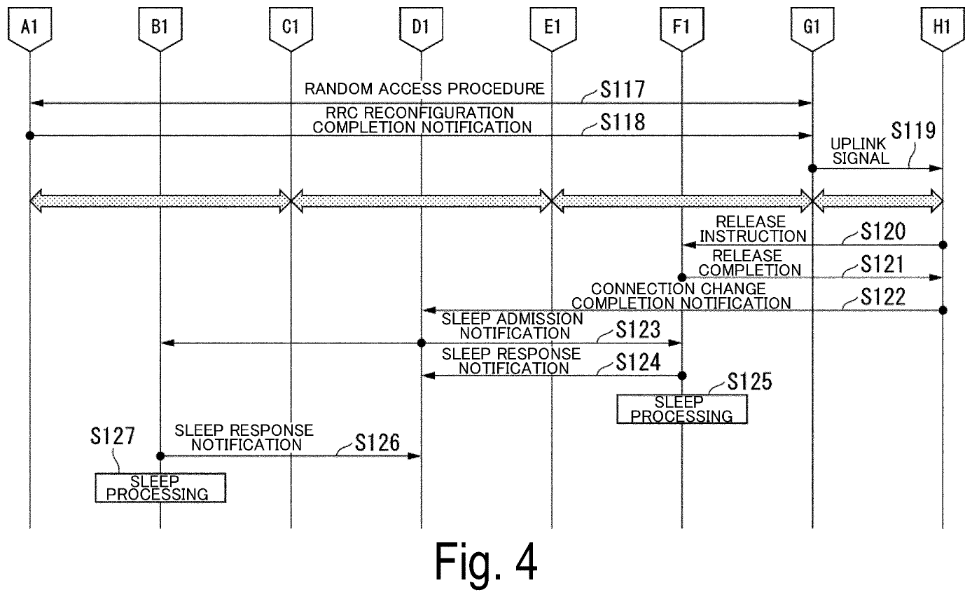

FIGS. 3 and 4 are sequence diagrams showing an example of a detailed flow of the sleep processing executed by the mobile NW system 100 in the first embodiment. In the explanation of FIGS. 3 and 4, the wireless station 12-1 is a destination wireless station, the wireless station 12-2 is a source wireless station, the distributed station 14-1 is a destination distributed station, and the distributed station 14-2 is a source distributed station. Therefore, in FIGS. 3 and 4, the wireless station 12-1, the wireless station 12-2, the distributed station 14-1, and the distributed station 14-2 are described as the destination wireless station 12-1, the source wireless station 12-2, the destination distributed station 14-1, and the source distributed station 14-2, respectively. The black arrows in FIGS. 3 and 4 represent user signals. In the following explanation, the user signals are also represented by black arrows in the drawings.

The acquisition unit 211 of the management control device 20 acquires cooperation information from the destination distributed station 14-1 and the source distributed station 14-2 at a predetermined period (steps S101 and S102). The acquisition unit 211 accumulates the acquired cooperation information in the cooperation information accumulation unit 221. When the cooperation information is accumulated in the cooperation information accumulation unit 221, the real-time analysis unit 222 performs optical path switching and sleep control determination (step S103).

The optical path switching and sleep control determination in step S103 involves determining whether the first switching condition is satisfied. Here, it is assumed that the first switching condition is satisfied. If the first switching condition is satisfied, the real-time analysis unit 222 notifies the control unit 23 of the control information.

The optical path switching control unit 231 transmits, to the transfer device 13, switching destination information including information indicating the destination wireless station and the destination distributed station included in the control information notified from the real-time analysis unit 222 (step S104). Here, the switching destination information includes information indicating the destination wireless station 12-1 and the destination distributed station 14-1 as the destination of the optical path switching. Furthermore, the optical path switching control unit 231 determines the source wireless station 12-2 and the source distributed station 14-2 as the source of the optical path switching based on the information indicating the source wireless station and the source distributed station included in the control information notified from the real-time analysis unit 222. The optical path switching control unit 231 transmits an optical path switching instruction and a terminal connection change instruction to the determined source wireless station 12-2 and source distributed station 14-2 (step S105).

The source distributed station 14-2 requests the aggregation station 15 to switch the distributed station 14 to be connected to the terminal 11 associated with the switching of the optical path based on the optical path switching instruction and the terminal connection change instruction transmitted from the management control device 20 (step S106). The source wireless station 12-2 requests the aggregation station 15 to switch the wireless station 12 to be connected to the terminal 11 associated with the switching of the optical path based on the optical path switching instruction and the terminal connection change instruction transmitted from the management control device 20 (step S107).

In response to the request from the source distributed station 14-2, the aggregation station 15 transmits a terminal context change request to the source distributed station 14-2 (step S108). The terminal context change request is a notification requesting a change of terminal context. The source distributed station 14-2 transmits a response to the terminal context change request transmitted from the aggregation station 15 to the aggregation station 15 (step S109). In response to receiving the response to the terminal context change request, the aggregation station 15 transmits a terminal context setup request to the destination distributed station 14-1 (step S110). The destination distributed station 14-1 transmits a response to the terminal context setup request transmitted from the aggregation station 15 to the aggregation station 15 (step S111).

In response to receiving the response to the terminal context setup request, the aggregation station 15 transmits the terminal context change request to the source distributed station 14-2 again (step S112). In response to receiving the terminal context change request transmitted from the aggregation station 15, the source distributed station 14-2 transmits an RRC reconfiguration instruction to the terminal 11 (step S113). The terminal 11 to which the source distributed station 14-2 transmits the RRC reconfiguration instruction is the terminal 11 to be connected to the source wireless station 12-2 connected to the source distributed station 14-2. The terminal 11 performs processing according to the RRC reconfiguration instruction and changes the connection.

After transmitting the RRC reconfiguration instruction, the source distributed station 14-2 transmits a response to the terminal context change request to the aggregation station 15 (step S114). Then, the transfer device 13 instructs the source distributed station 14-2 and the source wireless station 12-2 connected to the source distributed station 14-2 to start switching the optical path according to the switching destination information (step S115). In this way, the optical path switching processing is performed (step S116). Specifically, the transfer device 13 switches the optical path between the source wireless station 12-2 and the source distributed station 14-2 to the optical path between the destination wireless station 12-1 and the destination distributed station 14-1.

After the optical path switching processing is performed, a random access procedure is performed between the terminal 11 and the destination distributed station 14-1 (step S117). The terminal 11 transmits an RRC reconfiguration completion notification indicating the completion of the RRC reconfiguration to the destination distributed station 14-1 via the destination wireless station 12-1 and the transfer device 13 (step S118). When the destination distributed station 14-1 receives the RRC reconfiguration completion notification, the destination distributed station 14-1 transfers the RRC reconfiguration completion notification to the aggregation station 15 as an uplink signal (step S119). When the aggregation station 15 receives the RRC reconfiguration completion notification transferred from the destination distributed station 14-1, the aggregation station 15 transmits a terminal context release instruction to the source distributed station 14-2 (step S120).

The source distributed station 14-2 receives the terminal context release instruction transmitted from the aggregation station 15. The source distributed station 14-2 releases the terminal context based on the received terminal context release instruction. When the release of the terminal context is completed, the source distributed station 14-2 notifies the aggregation station 15 that the release of the terminal context has been completed (step S121). When the release of the terminal context is completed in the source distributed station 14-2, the aggregation station 15 transmits a connection change completion notification to the management control device 20, indicating that the change of the connection of the terminal 11 and the switching of the optical path have been completed (step S122).

When the sleep control unit 232 of the management control device 20 receives the connection change completion notification, the sleep control unit 232 transmits a sleep admission notification to the source wireless station 12-2 and the source distributed station 14-2 (step S123). When the source distributed station 14-2 receives the sleep admission notification from the management control device 20, the source distributed station 14-2 transmits a sleep response notification to the management control device 20 (step S124). The sleep response notification is a signal including a content indicating that the sleep admission notification has been received. After transmitting the sleep response notification, the source distributed station 14-2 transitions to a sleep state (step S125). When the source wireless station 12-2 receives the sleep admission notification from the management control device 20, the source wireless station 12-2 transmits a sleep response notification to the management control device 20 (step S126). After transmitting the sleep response notification, the source wireless station 12-2 transitions to a sleep state (step S127).

The source distributed station 14-2 and the source wireless station 12-2 may transition to a sleep state at the same time, or the source wireless station 12-2 may transition to a sleep state before the source distributed station 14-2. That is, the processing of steps S124 and S126 may be performed at the same time, and the processing of steps S125 and S127 may be performed at the same time, or the processing of steps S124 and S125 may be performed after the processing of steps S126 and S127 is executed.

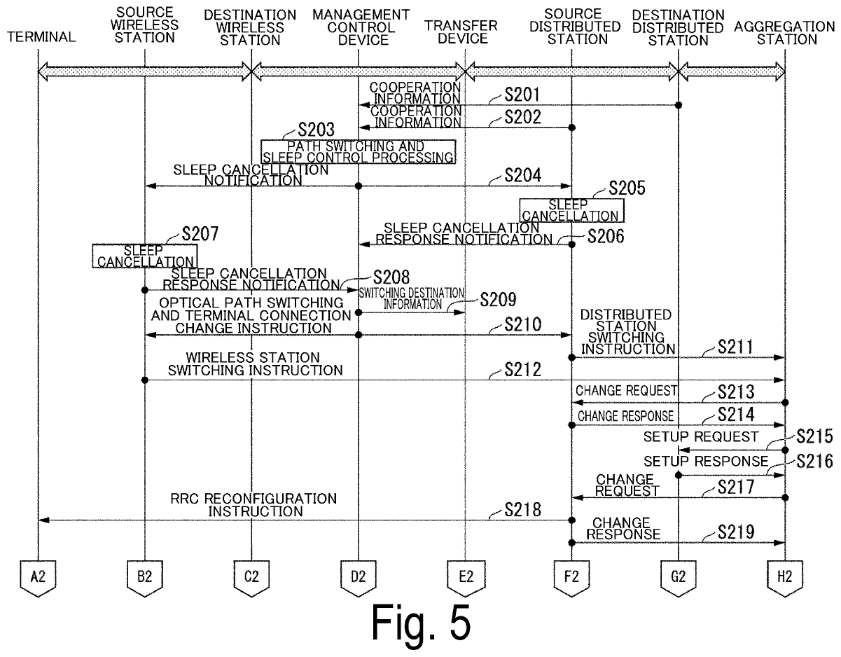

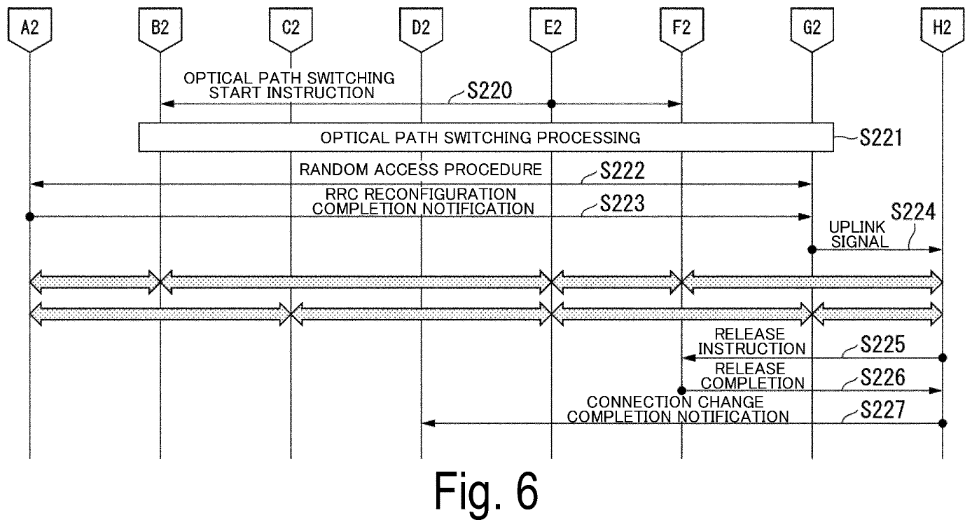

FIGS. 5 and 6 are sequence diagrams showing an example of a detailed flow of sleep cancellation processing executed by the mobile NW system 100 in the first embodiment. In the explanation of FIGS. 5 and 6, the wireless station 12-1 is a destination wireless station, the wireless station 12-2 is a source wireless station, the distributed station 14-1 is a destination distributed station, and the distributed station 14-2 is a source distributed station. Therefore, in FIGS. 5 and 6, the wireless station 12-1, the wireless station 12-2, the distributed station 14-1, and the distributed station 14-2 are described as the destination wireless station 12-1, the source wireless station 12-2, the destination distributed station 14-1, and the source distributed station 14-2, respectively. Furthermore, in the explanation of FIGS. 5 and 6, it is assumed that the source wireless station 12-2 and the source distributed station 14-2 are in a sleep state.

The acquisition unit 211 of the management control device 20 acquires cooperation information from the destination distributed station 14-1 and the source distributed station 14-2 at a predetermined period (steps S201 and S202). The acquisition unit 211 accumulates the acquired cooperation information in the cooperation information accumulation unit 221. When the cooperation information is accumulated in the cooperation information accumulation unit 221, the real-time analysis unit 222 performs optical path switching and sleep control determination (step S203). The optical path switching and sleep control determination in step S203 involves determining whether the first sleep cancellation condition is satisfied. Here, it is assumed that the first sleep cancellation condition is satisfied.

The sleep control unit 232 of the management control device 20 transmits a sleep cancellation notification to the source wireless station 12-2 and the source distributed station 14-2 (step S204). The sleep cancellation notification is a signal including a content indicating that the sleep state is to be canceled. The source distributed station 14-2 cancels the sleep state in response to receiving the sleep cancellation notification (step S205). After canceling the sleep state, the source distributed station 14-2 transmits a sleep cancellation response notification to the management control device 20 (step S206). The sleep cancellation response notification is a signal including a content indicating that the sleep cancellation notification has been received.

Note that the source distributed station 14-2 and the source wireless station 12-2 may cancel the sleep state at the same time, or the source wireless station 12-2 may cancel the sleep state before the source distributed station 14-2. That is, the processing of steps S205 and S207 may be performed at the same time, and the processing of steps S206 and S208 may be performed at the same time, or the processing of steps S205 and S206 may be performed after the processing of steps S207 and S208 is executed.

The source wireless station 12-2 cancels the sleep state in response to receiving the sleep cancellation notification (step S207). After canceling the sleep state, the source wireless station 12-2 transmits a sleep cancellation response notification to the management control device 20 (step S208). The optical path switching control unit 231 of the management control device 20 transmits switching destination information including information indicating the destination wireless station and the destination distributed station included in the control information notified from the real-time analysis unit 222 to the transfer device 13 (step S209). Here, the switching destination information includes information indicating the destination wireless station 12-1 and the destination distributed station 14-1 as the destination of the optical path switching.

Furthermore, the optical path switching control unit 231 determines the source wireless station 12-2 and the source distributed station 14-2 as the source of the optical path switching based on the information indicating the source wireless station and the source distributed station included in the control information notified from the real-time analysis unit 222. The optical path switching control unit 231 transmits an optical path switching instruction and a terminal connection change instruction to the determined source wireless station 12-2 and source distributed station 14-2 (step S210).

The source distributed station 14-2 requests the aggregation station 15 to switch the distributed station 14 to be connected to the terminal 11 associated with the switching of the optical path based on the optical path switching instruction and the terminal connection change instruction transmitted from the management control device 20 (step S211). Based on the optical path switching instruction and the terminal connection change instruction transmitted from the management control device 20, the source wireless station 12-2 requests the aggregation station 15 to switch the wireless station 12 to be connected to the terminal 11 associated with the switching of the optical path (step S212).

In response to the request from the source distributed station 14-2, the aggregation station 15 transmits a terminal context change request to the source distributed station 14-2 (step S213). The source distributed station 14-2 transmits a response to the terminal context change request transmitted from the aggregation station 15 to the aggregation station 15 (step S214). In response to receiving the response to the terminal context change request, the aggregation station 15 transmits a terminal context setup request to the destination distributed station 14-1 (step S215). The destination distributed station 14-1 transmits a response to the terminal context setup request transmitted from the aggregation station 15 to the aggregation station 15 (step S216).

In response to receiving the response to the terminal context setup request, the aggregation station 15 transmits a terminal context change request to the source distributed station 14-2 again (step S217). In response to receiving the terminal context change request transmitted from the aggregation station 15, the source distributed station 14-2 transmits an RRC reconfiguration instruction to the terminal 11 (step S218). The terminal 11 to which the source distributed station 14-2 transmits the RRC reconfiguration instruction is the terminal 11 to be connected to the source wireless station 12-2 connected to the source distributed station 14-2. The terminal 11 performs processing according to the RRC reconfiguration instruction and changes the connection.

After transmitting the RRC reconfiguration instruction, the source distributed station 14-2 transmits a response to the terminal context change request to the aggregation station 15 (step S219). Then, the transfer device 13 instructs the source distributed station 14-2 and the source wireless station 12-2 connected to the source distributed station 14-2 to start switching the optical path according to the switching destination information (step S220). In this way, the optical path switching processing is performed (step S221). Specifically, the transfer device 13 switches the optical path between the source wireless station 12-2 and the source distributed station 14-2 to the optical path between the destination wireless station 12-1 and the destination distributed station 14-1.

After the optical path switching processing is performed, a random access procedure is performed between the terminal 11 and the destination distributed station 14-1 (step S222).

The terminal 11 transmits an RRC reconfiguration completion notification indicating the completion of the RRC reconfiguration to the destination distributed station 14-1 via the destination wireless station 12-1 and the transfer device 13 (step S223). When the destination distributed station 14-1 receives the RRC reconfiguration completion notification, the destination distributed station 14-1 transfers the RRC reconfiguration completion notification to the aggregation station 15 as an uplink signal (step S224). When the aggregation station 15 receives the RRC reconfiguration completion notification transferred from the destination distributed station 14-1, the aggregation station 15 transmits a terminal context release instruction to the source distributed station 14-2 (step S225).

The source distributed station 14-2 receives the terminal context release instruction transmitted from the aggregation station 15. The source distributed station 14-2 releases the terminal context based on the received terminal context release instruction. When the release of the terminal context is completed, the source distributed station 14-2 notifies the aggregation station 15 that the release of the terminal context has been completed (step S226). When the release of the terminal context is completed in the source distributed station 14-2, the aggregation station 15 transmits a connection change completion notification to the management control device 20 (step S227).

According to the mobile NW system 100 configured as above, the management control device 20 includes the cooperation information collection unit 21 that acquires cooperation information at a predetermined period from one or more distributed stations 14 that perform wireless communication with one or more terminals, the analysis unit 22 that determines whether switching of the optical path is necessary based on the cooperation information, the optical path switching control unit 231 that transmits switching destination information including information on the destination of optical path switching to the transfer device 13 that switches the optical path connected to one or more wireless stations 12 and one or more distributed stations 14 when it is determined that the optical path switching is necessary, and instructs the wireless station 12 and distributed station 14 that are the sources of the optical path switching to change the connection of the terminal 11 associated with the switching of the optical path, and the sleep control unit 232 that causes the wireless station 12 and distributed station 14 that are the sources of the optical path switching to transition to a sleep state after the switching of the optical path and the connection change of the terminal 11 are performed. In this way, the optical path switching and the connection change of the terminal 11 can be performed in a series of processing. In this way, it is possible to prevent packet loss and delay.

Furthermore, the management control device 20 transitions the wireless station 12 and the distributed station 14, which are the switching sources of a disconnected optical path, to a sleep state. In this way, it is possible to reduce power consumption.

### First Modification Example of First Embodiment

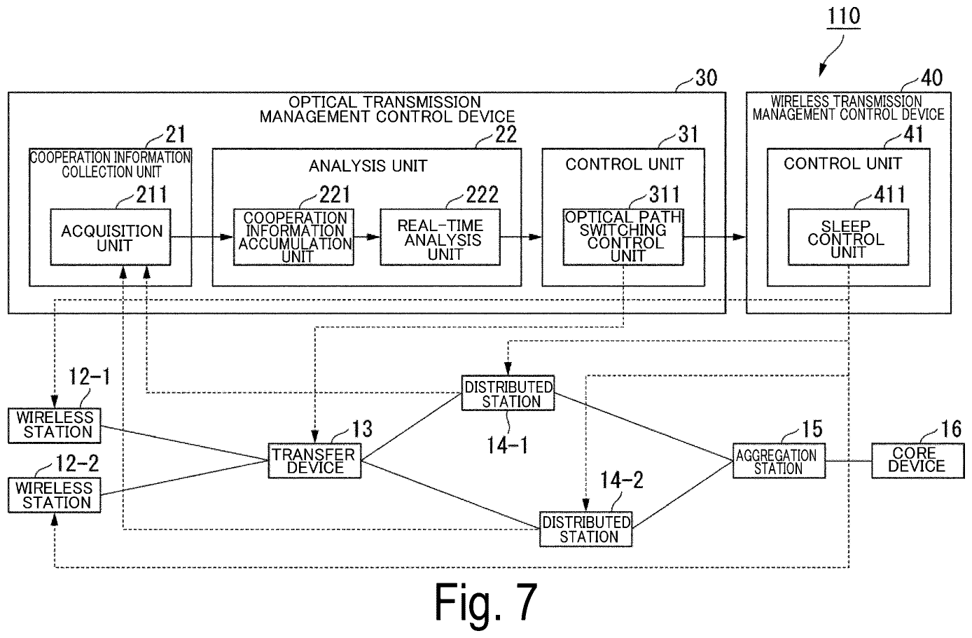

In the above-mentioned embodiment, the management control device 20 performs the optical path switching control processing and the sleep control processing. The optical path switching control processing and the sleep control processing may be performed by different devices. FIG. 7 is a diagram showing a configuration example of a mobile NW system 110 in a first modification example of the first embodiment. The mobile NW system 110 includes a plurality of wireless stations 12, a transfer device 13, a plurality of distributed stations 14, an aggregation station 15, a core device 16, an optical transmission management control device 30, and a wireless transmission management control device 40. As shown in FIG. 7, the mobile NW system 110 includes the optical transmission management control device 30 and the wireless transmission management control device 40 instead of the management control device 20.

The optical transmission management control device 30 controls an optical transmission section. The optical transmission section refers to a section connected by an optical fiber. The optical transmission section is, for example, a section between the wireless station 12 and the transfer device 13, between the transfer device 13 and the distributed station 14, between the distributed station 14 and the aggregation station 15, and between the aggregation station 15 and the core device 16.

The optical transmission management control device 30 includes a cooperation information collection unit 21, an analysis unit 22, and a control unit 31. The cooperation information collection unit 21 and the analysis unit 22 perform the same processing as the cooperation information collection unit 21 and the analysis unit 22 provided in the above-mentioned management control device 20. The control unit 31 includes an optical path switching control unit 311. The optical path switching control unit 311 performs the same processing as the optical path switching control unit 231 provided in the above-mentioned management control device 20.

The wireless transmission management control device 40 controls a wireless transmission section. The wireless transmission section refers to a section connected by an optical fiber. The wireless transmission section is, for example, a section between the terminal 11 and the wireless station 12. The wireless transmission management control device 40 includes a control unit 41. The control unit 41 includes a sleep control unit 411. The sleep control unit 411 performs the same processing as the sleep control unit 232 included in the management control device 20 described above.

The real-time analysis unit 222 of the optical transmission management control device 30 transmits control information including information indicating the wireless station 12 and distributed station 14 to be subjected to sleep control to the wireless transmission management control device 40. The wireless transmission management control device 40 causes the wireless station 12 and distributed station 14 to be subjected to sleep control to execute sleep or cancel sleep based on the control information transmitted from the optical transmission management control device 30.

By configuring in this way, different processing such as switching of optical paths and sleep control can be performed by a plurality of devices. In this way, the amount of processing to be performed by one device can be reduced.

### Second Modification Example of First Embodiment

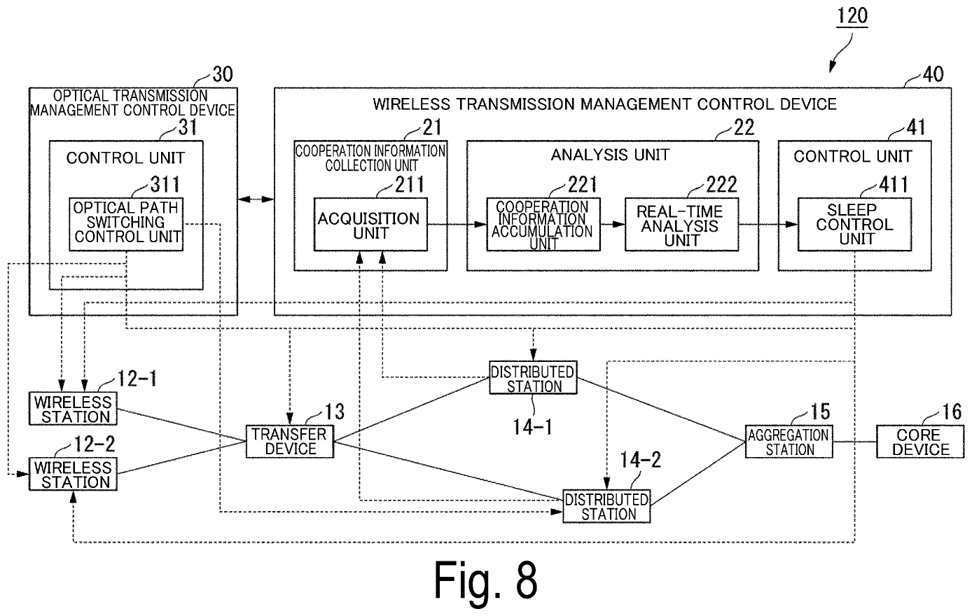

In the above-mentioned embodiment, the configuration in which the management control device 20 performs the optical path switching control processing and the sleep control processing has been shown. The optical path switching control processing and the sleep control processing may be performed by different devices. FIG. 8 is a diagram showing a configuration example of a mobile NW system 120 in the second modification example of the first embodiment. The mobile NW system 120 includes a plurality of wireless stations 12, a transfer device 13, a plurality of distributed stations 14, an aggregation station 15, a core device 16, an optical transmission management control device 30, and a wireless transmission management control device 40. As shown in FIG. 8, the mobile NW system 120 includes the optical transmission management control device 30 and the wireless transmission management control device 40 instead of the management control device 20.

The optical transmission management control device 30 controls an optical transmission section. The optical transmission management control device 30 includes a control unit 31. The control unit 31 includes an optical path switching control unit 311. The optical path switching control unit 311 performs the same processing as the optical path switching control unit 231 included in the management control device 20 described above.

The wireless transmission management control device 40 controls a wireless transmission section. The wireless transmission management control device 40 includes a cooperation information collection unit 21, an analysis unit 22, and a control unit 41. The cooperation information collection unit 21 and the analysis unit 22 perform the same processing as the cooperation information collection unit 21 and the analysis unit 22 included in the management control device 20 described above. The control unit 41 includes a sleep control unit 411. The sleep control unit 411 performs the same processing as the sleep control unit 232 included in the management control device 20 described above.

The real-time analysis unit 222 of the wireless transmission management control device 40 transmits control information including information indicating a source wireless station and a source distributed station, and information indicating a destination wireless station and a destination distributed station to the optical transmission management control device 30. The optical transmission management control device 30 switches the optical path based on the control information transmitted from the wireless transmission management control device 40.

By configuring in this way, different processing such as optical path switching and sleep control can be performed by a plurality of devices. In this way, the amount of processing to be performed by one device can be reduced.

### Third Modification Example Of First Embodiment

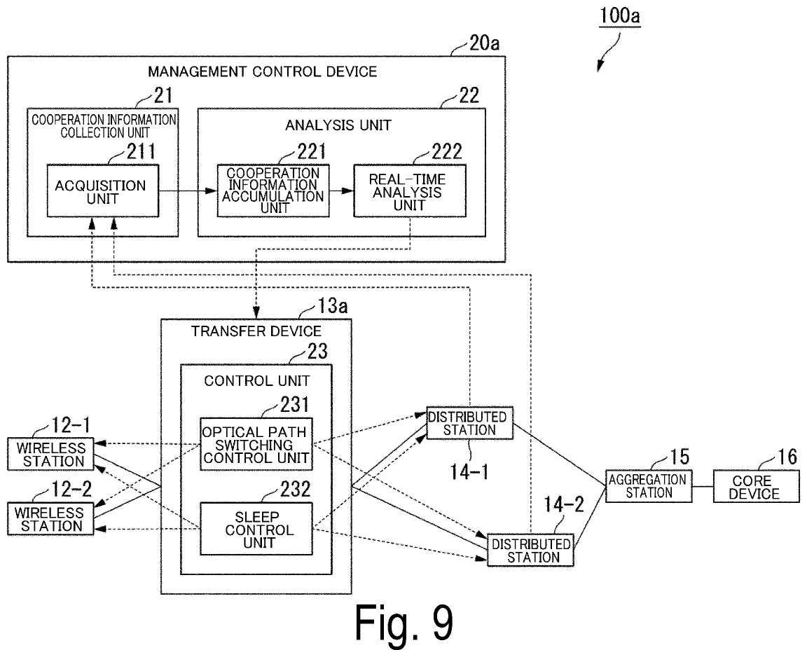

In the above-mentioned embodiment, the management control device 20 performs the optical path switching control processing and the sleep control processing. In contrast, the transfer device 13 may be configured to perform the optical path switching control processing and the sleep control processing. FIG. 9 is a diagram showing a configuration example of a mobile NW system 100a in a third modification example of the first embodiment. The mobile NW system 100a includes a plurality of wireless stations 12, a transfer device 13a, a plurality of distributed stations 14, an aggregation station 15, a core device 16, and a management control device 20a.

As shown in FIG. 9, the transfer device 13a includes a control unit 23, and the management control device 20a does not include a control unit 23. The real-time analysis unit 222 of the management control device 20a notifies the transfer device 13a of the control information. In addition, the real-time analysis unit 222 may notify the transfer device 13a of control information only when optical path switching and sleep control are performed. The control unit 23 of the transfer device 13a performs optical path switching control processing and sleep control processing based on the control information notified from the management control device 20a.

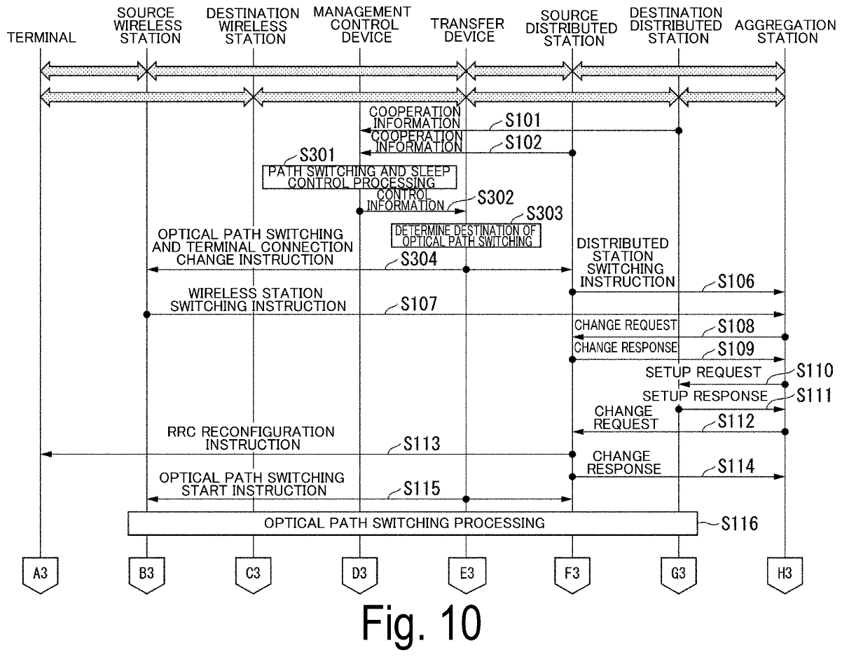

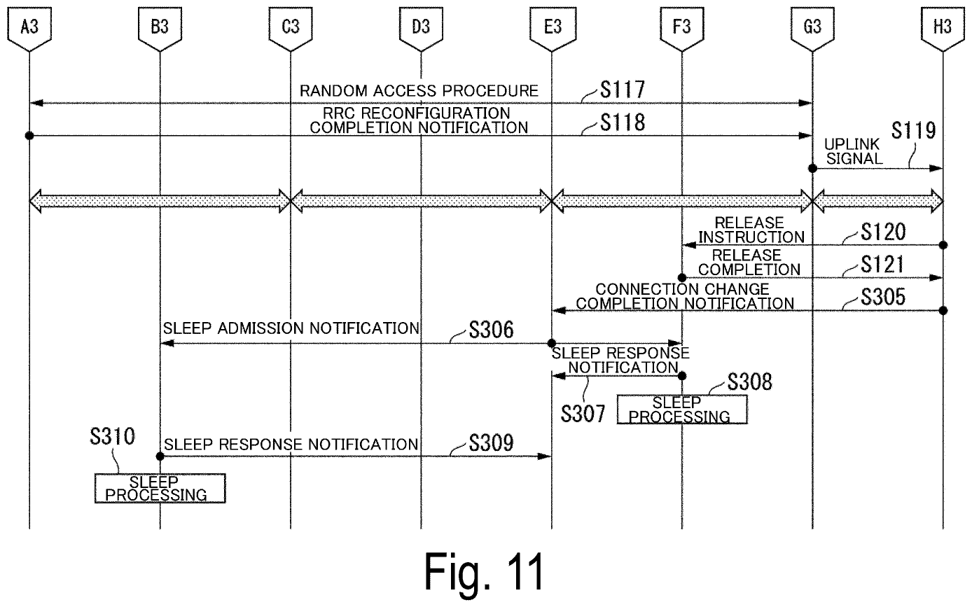

FIGS. 10 and 11 are sequence diagrams showing an example of a detailed flow of the sleep processing executed by the mobile NW system 100a in the third modification example of the first embodiment. In FIGS. 10 and 11, the same processing steps as those in FIGS. 3 and 4 are denoted by the same reference numerals as those in FIGS. 3 and 4, and the description thereof will be omitted.

After the processing from step S101 to step S102 is executed, the real-time analysis unit 222 performs optical path switching and sleep control determination when the cooperation information is accumulated in the cooperation information accumulation unit 221 (step S301). The optical path switching and sleep control determination in step S301 involves determining whether the first switching condition is satisfied. Here, it is assumed that the first switching condition is satisfied. When the first switching condition is satisfied, the real-time analysis unit 222 transmits control information to the transfer device 13a (step S302). The transfer device 13a receives the control information transmitted from the management control device 20a.

The optical path switching control unit 231 of the transfer device 13a determines the destination wireless station 12-1 and the destination distributed station 14-1 as the destination of the optical path switching based on the information indicating the destination wireless station and the destination distributed station included in the received control information (step S303). Furthermore, the optical path switching control unit 231 determines the source wireless station 12-2 and the source distributed station 14-2 as the source of the optical path switching based on the information indicating the source wireless station and the source distributed station included in the received control information. The optical path switching control unit 231 transmits an optical path switching instruction and a terminal connection change instruction to the determined source wireless station 12-2 and source distributed station 14-2 (step S304). Subsequently, processing from step S106 to step S121 is executed.

After the processing of step S121 is executed, when the release of the terminal context is completed in the source distributed station 14-2, the aggregation station 15 transmits a connection change completion notification to the transfer device 13a (step S305). When the sleep control unit 232 of the transfer device 13a receives the connection change completion notification, the sleep control unit 232 transmits a sleep admission notification to the source wireless station 12-2 and the source distributed station 14-2 (step S306). When the source distributed station 14-2 receives the sleep admission notification from the transfer device 13a, the source distributed station 14-2 transmits a sleep response notification to the transfer device 13a (step S307). After transmitting the sleep response notification, the source distributed station 14-2 transitions to a sleep state (step S308). When the source wireless station 12-2 receives the sleep admission notification from the transfer device 13a, the source wireless station 12-2 transmits a sleep response notification to the transfer device 13a (step S309). After transmitting the sleep response notification, the source wireless station 12-2 transitions to a sleep state (step S310).

The source distributed station 14-2 and the source wireless station 12-2 may transition to a sleep state at the same time, or the source wireless station 12-2 may transition to a sleep state before the source distributed station 14-2. That is, the processing of steps S307 and S309 may be performed at the same time, and the processing of steps S308 and S310 may be performed at the same time, or the processing of steps S307 and S308 may be performed after the processing of steps S309 and S310 is executed.

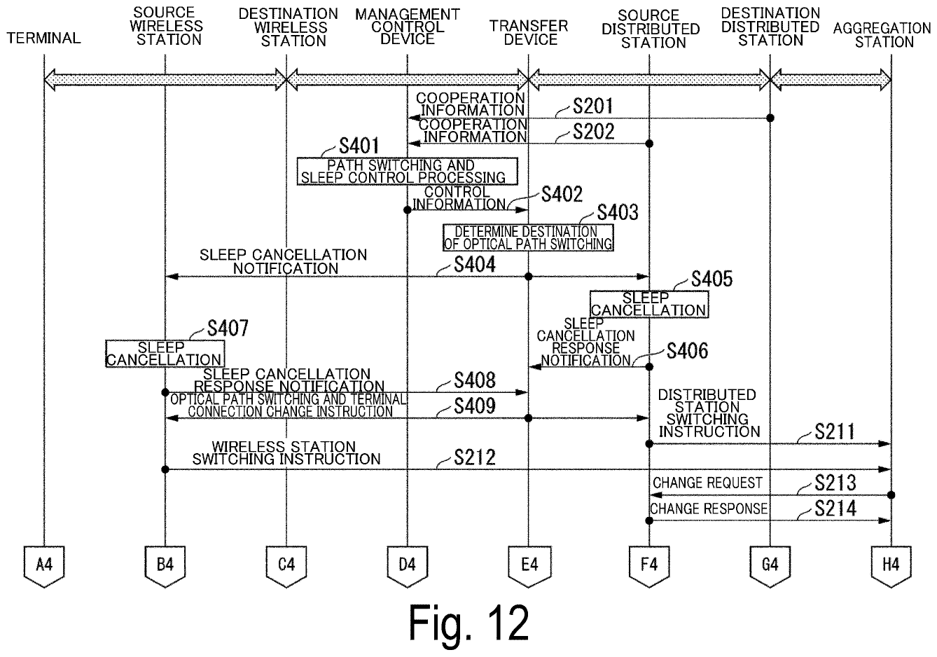

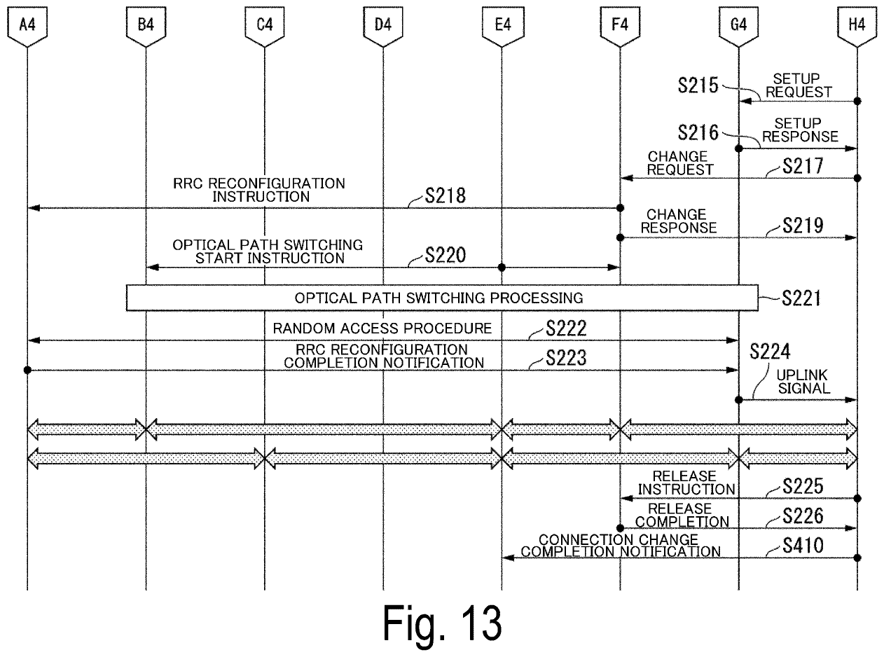

FIGS. 12 and 13 are sequence diagrams showing an example of a detailed flow of sleep cancellation processing executed by the mobile NW system 100a in the third modification example of the first embodiment. In FIGS. 12 and 13, the same processing steps as those in FIGS. 5 and 6 are denoted by the same reference numerals as those in FIGS. 5 and 6, and the description thereof will be omitted. In the explanation of FIGS. 12 and 13, it is assumed that the source wireless station 12-2 and the source distributed station 14-2 are in a sleep state.

After the processing from step S201 to step S202 is executed, when the cooperation information is accumulated in the cooperation information accumulation unit 221, the real-time analysis unit 222 performs optical path switching and sleep control determination (step S401). The optical path switching and sleep control determination in step S401 involves determining whether the first sleep cancellation condition is satisfied. Here, it is assumed that the first sleep cancellation condition is satisfied. When the first sleep cancellation condition is satisfied, the real-time analysis unit 222 transmits control information to the transfer device 13a (step S402). The transfer device 13a receives the control information transmitted from the management control device 20a.

The optical path switching control unit 231 of the transfer device 13a determines the destination wireless station 12-1 and the destination distributed station 14-1 as the destination of the optical path switching based on the information indicating the destination wireless station and the destination distributed station included in the received control information (step S403). The sleep control unit 232 transmits a sleep cancellation notification to the source wireless station 12-2 and the source distributed station 14-2 (step S404). The source distributed station 14-2 cancels the sleep state in response to receiving the sleep cancellation notification (step S405). After canceling the sleep state, the source distributed station 14-2 transmits a sleep cancellation response notification to the transfer device 13a (step S406).

The source wireless station 12-2 cancels the sleep state in response to receiving the sleep cancellation notification (step S407). After canceling the sleep state, the source wireless station 12-2 transmits a sleep cancellation response notification to the transfer device 13a (step S408). The source distributed station 14-2 and the source wireless station 12-2 may cancel the sleep state at the same time, or the source wireless station 12-2 may cancel the sleep state before the source distributed station 14-2. That is, the processing of steps S405 and S407 may be performed at the same time, and the processing of steps S406 and S408 may be performed at the same time, or the processing of steps S405 and S406 may be performed after the processing of steps S407 and S408 is executed.

The optical path switching control unit 231 of the transfer device 13a determines the source wireless station 12-2 and the source distributed station 14-2 as the source of the optical path switching based on the information indicating the source wireless station and the source wireless station included in the received control information. The optical path switching control unit 231 transmits an optical path switching instruction and a terminal connection change instruction to the determined source wireless station 12-2 and source distributed station 14-2 (step S409). Subsequently, processing from step S211 to step S226 is executed. When the release of the terminal context is completed in the source distributed station 14-2, the aggregation station 15 transmits a connection change completion notification to the transfer device 13a (step S410).

### Second Embodiment

In the first embodiment, a configuration in which the wireless station 12 and the distributed station 14 are connected via the transfer device 13 is described. In the second embodiment, a configuration in which the wireless station 12 and the distributed station 14 are connected without the transfer device 13 is described.

### Outline of Second Embodiment

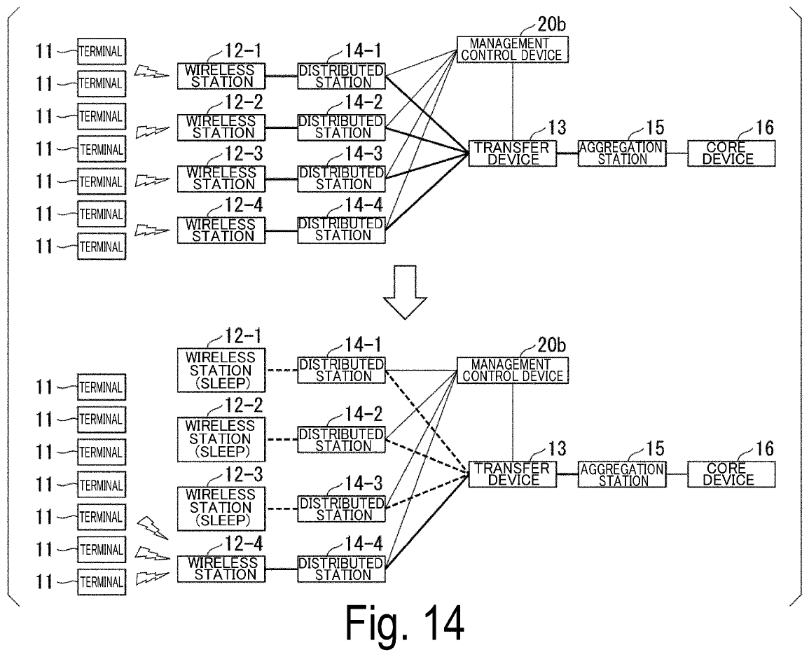

FIG. 14 is a diagram for explaining the outline of the processing of the mobile NW system in the second embodiment. First, the overall configuration of the mobile NW system in the second embodiment is described. The mobile NW system in the second embodiment is an example of a communication system. The mobile NW system in the second embodiment is, for example, 5G. The mobile NW system in the second embodiment includes a plurality of wireless stations 12, a transfer device 13, a plurality of distributed stations 14, an aggregation station 15, a core device 16, and a management control device 20b.

The mobile NW system in the second embodiment differs from the first embodiment in that the distributed stations 14 are arranged between the wireless stations 12 and the transfer device 13. Furthermore, the mobile NW system in the second embodiment differs from the first embodiment in the processing performed by the management control device 20b. The following description will focus on differences from the first embodiment.

The upper diagram of FIG. 14 shows the connection state of the mobile NW system before optical path switching, and the lower diagram of FIG. 14 shows the connection state of the mobile NW system after optical path switching. The upper diagram of FIG. 14 shows an example in which the wireless stations 12-1 to 12-4 and the distributed stations 14-1 to 14-4 are connected one-to-one, respectively. For example, the wireless station 12-1 is connected to the distributed station 14-1 via the transfer device 13, the wireless station 12-2 is connected to the distributed station 14-2 via the transfer device 13, the wireless station 12-3 is connected to the distributed station 14-3 via the transfer device 13, and the wireless station 12-4 is connected to the distributed station 14-4 via the transfer device 13.

The management control device 20b determines whether to perform the optical path switching control processing based on the cooperation information collected from each distributed station 14. The cooperation information in the second embodiment includes, for example, traffic information that the distributed station 14 receives from the aggregation station 15 in the downlink and traffic information that the distributed station 14 sends to the aggregation station 15 in the uplink. The management control device 20b compares the traffic volume indicated by the traffic information included in the collected cooperation information with a switching determination threshold stored in advance. When the management control device 20b determines to perform the optical path switching control processing, the management control device 20b transmits switching destination information to the transfer device 13. Furthermore, the management control device 20b transmits an optical path switching instruction to the distributed station 14 to be subjected to optical path switching.

For example, it is assumed that the management control device 20b selects the distributed stations 14-1 to 14-3 as the targets of optical path switching. In this case, the management control device 20b transmits an optical path switching instruction to the distributed stations 14-1 to 14-3. According to the optical path switching instruction transmitted from the management control device 20b, the distributed stations 14-1 to 14-3 request the aggregation station 15 to change the connection of the terminal 11 associated with the switching of the optical path. In response to the request transmitted from the distributed stations 14-1 to 14-3, the aggregation station 15 performs processing of changing the connection of the terminal 11 for the distributed stations 14-1 to 14-3.

The distributed stations 14-1 to 14-3 transmit an RRC reconfiguration instruction to the terminal 11 to which they are connected. When the terminal 11 receives an RRC reconfiguration instruction from the distributed stations 14-1 to 14-3 to which it was connected, the terminal 11 performs processing according to the RRC reconfiguration instruction and changes the connection. When the processing by the source distributed stations 14-1 to 14-3 is completed, the transfer device 13 switches the optical path. After the optical path switching is completed, the transfer device 13 notifies the management control device 20b of the completion of the optical path switching.

When the management control device 20b receives a notification of the completion of the optical path switching from the transfer device 13, the management control device 20b transmits a sleep admission notification to the source distributed stations 14-1 to 14-3. As a result, the source distributed stations 14-1 to 14-3 transition to a sleep state.

The lower diagram of FIG. 14 shows an example in which the terminal 11 connected to the distributed stations 14-1 to 14-3 connects to the wireless station 12-4, and the distributed stations 14-1 to 14-3 transition to a sleep state. In this way, in the mobile NW system in the second embodiment, the optical path between the wireless station 12 and the distributed station 14 is switched after the connection change of the terminal 11 is completed.

When a new terminal is connected to the sleep target distributed station 14 or the connection of the terminal 11 is changed from another base station, the aggregation station 15 may instruct the source distributed station 14 to reject the new terminal connection after receiving a switching instruction from the source distributed station 14.

### Details of Second Embodiment

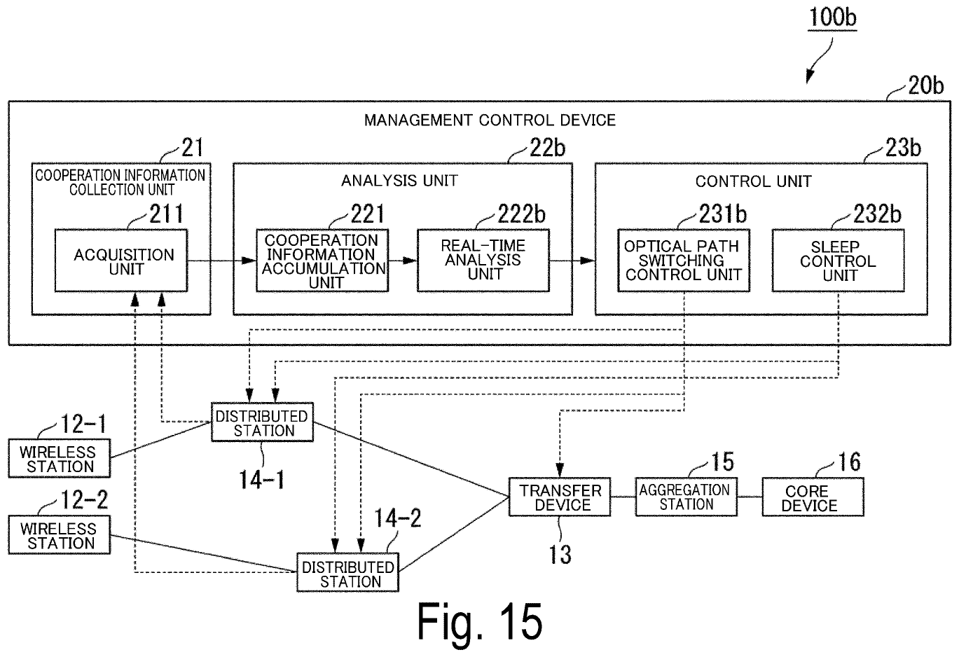

FIG. 15 is a diagram showing a configuration example of a mobile NW system 100b in the second embodiment. The mobile NW system 100b in the second embodiment includes a plurality of wireless stations 12, a transfer device 13, a plurality of distributed stations 14, an aggregation station 15, a core device 16, and a management control device 20b. In the following description, the mobile NW system 100b includes two wireless stations 12 and two distributed stations 14. Note that the configurations of the wireless stations 12, the transfer device 13, the distributed stations 14, the aggregation station 15, and the core device 16 are the same as those in the first embodiment, and therefore will not be described. The management control device 20b includes a cooperation information collection unit 21, an analysis unit 22b, and a control unit 23b.

The analysis unit 22b includes a cooperation information accumulation unit 221 and a real-time analysis unit 222b. The real-time analysis unit 222b analyzes the state of communication between each distributed station 14 and the terminal 11 based on the cooperation information. Specifically, the real-time analysis unit 222b determines whether optical path switching and sleep control are necessary based on the cooperation information.

When determining whether optical path switching and sleep control are necessary, the real-time analysis unit 222b compares a switching determination threshold stored in advance with the traffic volume indicated by the traffic information included in the collected cooperation information. The real-time analysis unit 222b stores a switching determination threshold for each distributed station 14. The switching determination threshold may be the same for all distributed stations 14, or may be different for only some of the distributed stations 14.

The real-time analysis unit 222b determines whether a second switching condition is satisfied as a result of the comparison. The second switching condition is a condition indicating that switching of the optical path between the distributed station 14 and the aggregation station 15 is necessary. The second switching condition is, for example, that the switching determination threshold for the source distributed station is greater than the traffic volume obtained from the source distributed station, and that the switching determination threshold for the destination distributed station is greater than the traffic volume obtained from the destination distributed station.

The real-time analysis unit 222b determines to perform the optical path switching control processing when the second switching condition is satisfied. On the other hand, the real-time analysis unit 222b determines not to perform the optical path switching control processing when the second switching condition is not satisfied. When the real-time analysis unit 222b determines to perform the optical path switching control processing, the real-time analysis unit 222b notifies the control unit 23b of control information including information indicating the source distributed station, information indicating the destination distributed station, and information indicating the distributed station 14 to be subjected to sleep control.

Here, in the second embodiment, the distributed station to be the source of the optical path switching when the second switching condition is satisfied is, for example, the distributed station 14-2. In the second embodiment, the distributed station to be the destination of the optical path switching when the second switching condition is satisfied is, for example, the distributed station 14-1. In the second embodiment, the distributed station to be subjected to sleep control when the second switching condition is satisfied is, for example, the distributed station 14-2 to be the source of the optical path switching. In this way, the real-time analysis unit 222b aggregates traffic by switching the optical path of the distributed station 14-2, through which the volume of traffic flowing is small, to the distributed station 14-1, through which the volume of traffic flowing is small.

The real-time analysis unit 222b further determines whether the second sleep cancellation condition is satisfied as a result of the comparison. The second sleep cancellation condition is a condition indicating that the sleep of the sleeping distributed station 14 is to be canceled.

The second sleep cancellation condition is, for example, that the traffic volume of the distributed station 14 that is the switching destination under the second switching condition is greater than the switching determination threshold for the distributed station 14 that is the switching destination under the second switching condition. In this way, the second sleep cancellation condition is a condition for canceling the sleep state of the sleeping distributed station when the traffic of the distributed station 14 that is the switching destination under the second switching condition increases.

The real-time analysis unit 222b determines to perform the optical path switching control processing when the second sleep cancellation condition is satisfied. On the other hand, the real-time analysis unit 222b determines not to perform the optical path switching control processing when the second sleep cancellation condition is not satisfied. When the real-time analysis unit 222b determines to perform the optical path switching control processing, the real-time analysis unit 222b notifies the control unit 23b of control information including information indicating the source distributed station, information indicating the destination distributed station, and information indicating the distributed station 14 to be subjected to sleep control.

The control unit 23b includes an optical path switching control unit 231b and a sleep control unit 232b. The optical path switching control unit 231b determines the destination distributed station based on the analysis result from the real-time analysis unit 222b. The optical path switching control unit 231b transmits switching destination information including information indicating the determined distributed station 14 that is the destination of the optical path switching to the transfer device 13. As a result, the optical path switching control unit 231b instructs the transfer device 13 to switch the optical path.

Furthermore, the optical path switching control unit 231b determines a source distributed station based on the analysis result from the real-time analysis unit 222b. The optical path switching control unit 231b transmits an optical path switching instruction and a terminal connection change instruction to the determined distributed station 14 that is the source of optical path switching.

The sleep control unit 232b causes the distributed station 14 to be subjected to sleep control to execute sleep or cancel sleep based on the analysis result from the real-time analysis unit 222b.

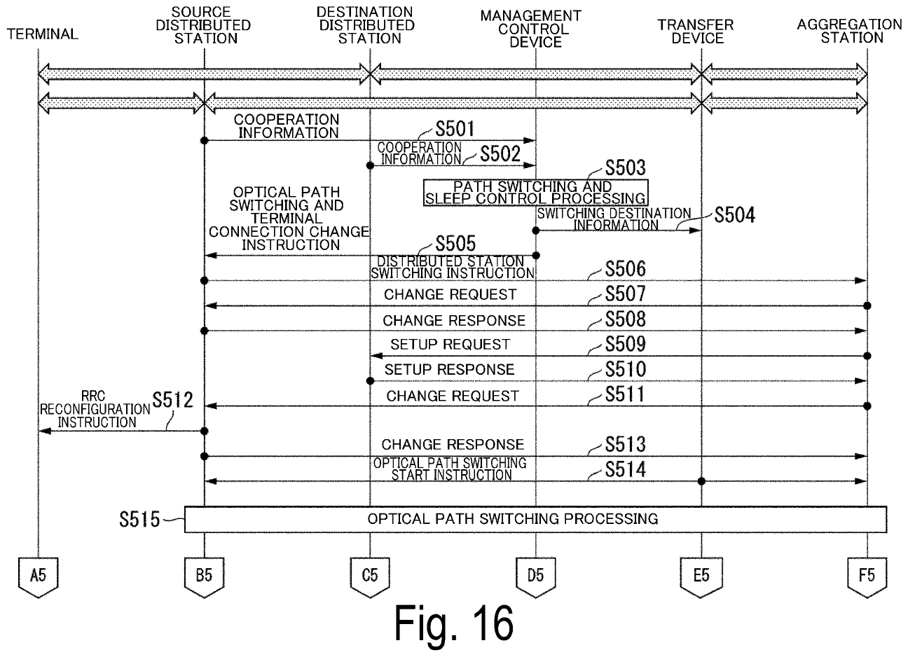

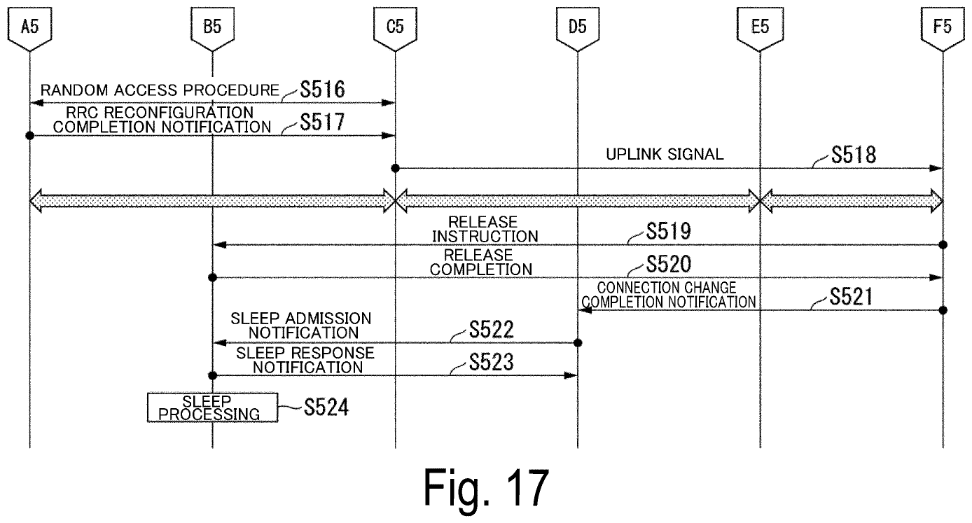

FIGS. 16 and 17 are sequence diagrams showing an example of a detailed flow of sleep processing executed by the mobile NW system 100b in the second embodiment. Note that in the explanation of FIGS. 16 and 17, the distributed station 14-1 is a destination distributed station and the distributed station 14-2 is a source distributed station. Therefore, in the explanation of FIGS. 16 and 17, the distributed station 14-1 and the distributed station 14-2 are described as the destination distributed station 14-1 and the source distributed station 14-2, respectively.

The acquisition unit 211 of the management control device 20b acquires the cooperation information from the destination distributed station 14-1 and the source distributed station 14-2 at a predetermined period (steps S501 and S502). The acquisition unit 211 accumulates the acquired cooperation information in the cooperation information accumulation unit 221. When the cooperation information is accumulated in the cooperation information accumulation unit 221, the real-time analysis unit 222b performs optical path switching and sleep control determination (step S503).

The optical path switching and sleep control determination in step S503 involves determining whether the second switching condition is satisfied. Here, it is assumed that the second switching condition is satisfied. When the second switching condition is satisfied, the real-time analysis unit 222b notifies the control unit 23b of the control information.

The optical path switching control unit 231b transmits, to the transfer device 13, switching destination information including information indicating the destination distributed station included in the control information notified from the real-time analysis unit 222b (step S504). Here, the switching destination information includes information indicating the destination distributed station 14-1 as the destination of the optical path switching. Furthermore, the optical path switching control unit 231b determines the source distributed station 14-2 as the source of the optical path switching based on the information indicating the source distributed station included in the control information notified from the real-time analysis unit 222b. The optical path switching control unit 231b transmits an optical path switching instruction and a terminal connection change instruction to the determined source distributed station 14-2 (step S505).

The source distributed station 14-2 requests the aggregation station 15 to switch the distributed station 14 to be connected to the terminal 11 associated with the switching of the optical path based on the optical path switching instruction and the terminal connection change instruction transmitted from the management control device 20b (step S506). In response to the request from the source distributed station 14-2, the aggregation station 15 transmits a terminal context change request to the source distributed station 14-2 (step S507). The source distributed station 14-2 transmits a response to the terminal context change request transmitted from the aggregation station 15 to the aggregation station 15 (step S508). In response to receiving the response to the terminal context change request, the aggregation station 15 transmits a terminal context setup request to the destination distributed station 14-1 (step S509). The destination distributed station 14-1 transmits a response to the terminal context setup request transmitted from the aggregation station 15 to the aggregation station 15 (step S510).

In response to receiving the response to the terminal context setup request, the aggregation station 15 transmits the terminal context change request to the source distributed station 14-2 again (step S511). In response to receiving the terminal context change request transmitted from the aggregation station 15, the source distributed station 14-2 transmits an RRC reconfiguration instruction to the terminal 11 (step S512). The terminal 11 to which the source distributed station 14-2 transmits the RRC reconfiguration instruction is the terminal 11 to be connected to the source wireless station 12-2 connected to the source distributed station 14-2. The terminal 11 performs processing according to the RRC reconfiguration instruction and changes the connection.

After transmitting the RRC reconfiguration instruction, the source distributed station 14-2 transmits a response to the terminal context change request to the aggregation station 15 (step S513). Then, the transfer device 13 instructs the source distributed station 14-2 and the aggregation station 15 to start switching the optical path according to the switching destination information (step S514). In this way, the optical path switching processing is performed (step S515). Specifically, the transfer device 13 switches the optical path between the source distributed station 14-2 and the aggregation station 15 to the optical path between the destination distributed station 14-1 and the aggregation station 15.

After the optical path switching processing is performed, a random access procedure is performed between the terminal 11 and the destination distributed station 14-1 (step S516). The terminal 11 transmits an RRC reconfiguration completion notification indicating the completion of the RRC reconfiguration to the destination distributed station 14-1 via the destination wireless station 12-1 and the transfer device 13 (step S517). When the destination distributed station 14-1 receives the RRC reconfiguration completion notification, the destination distributed station 14-1 transfers the RRC reconfiguration completion notification to the aggregation station 15 as an uplink signal (step S518). When the aggregation station 15 receives the RRC reconfiguration completion notification transferred from the destination distributed station 14-1, the aggregation station 15 transmits a terminal context release instruction to the source distributed station 14-2 (step S519).

The source distributed station 14-2 receives the terminal context release instruction transmitted from the aggregation station 15. The source distributed station 14-2 releases the terminal context based on the received terminal context release instruction. When the release of the terminal context is completed, the source distributed station 14-2 notifies the aggregation station 15 that the release of the terminal context has been completed (step S520). When the release of the terminal context is completed in the source distributed station 14-2, the aggregation station 15 transmits a connection change completion notification to the management control device 20b (step S521).

When the connection change completion notification is received, the sleep control unit 232b of the management control device 20b transmits a sleep admission notification to the source distributed station 14-2 (step S522). When the source distributed station 14-2 receives the sleep admission notification from the management control device 20b, the source distributed station 14-2 transmits a sleep response notification to the management control device 20b (step S523). After transmitting the sleep response notification, the source distributed station 14-2 transitions to a sleep state (step S524).

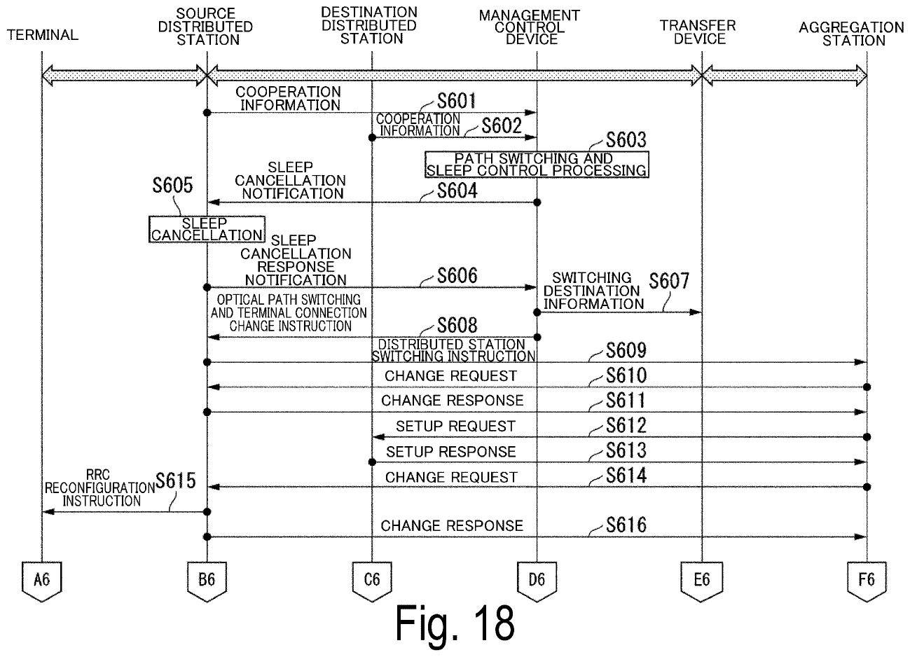

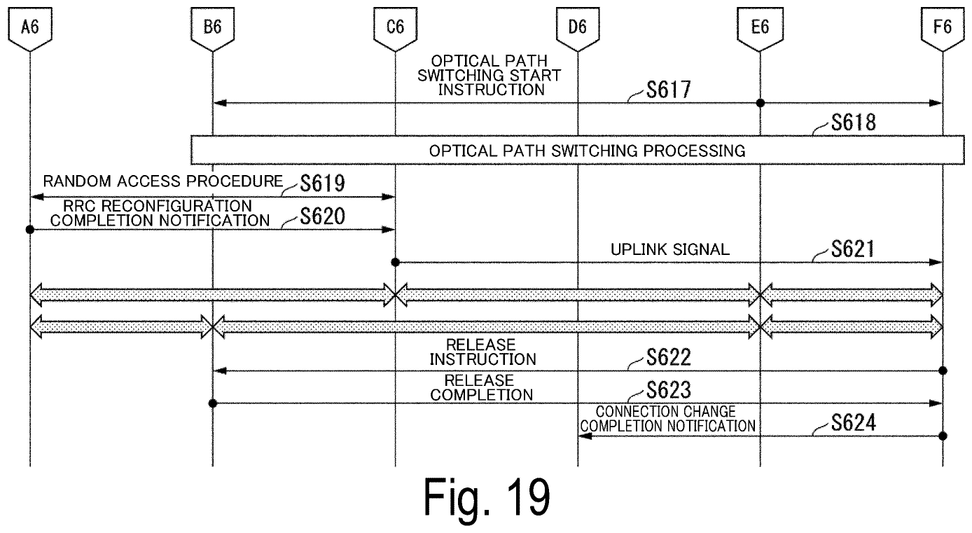

FIGS. 18 and 19 are sequence diagrams showing an example of a detailed flow of sleep cancellation processing executed by the mobile NW system 100b in the second embodiment. In the explanation of FIGS. 18 and 19, the distributed station 14-1 is a destination distributed station, and the distributed station 14-2 is a source distributed station. Therefore, in FIGS. 18 and 19, the destination distributed station 14-1 and the source distributed station 14-2 are described as the destination distributed station 14-1 and the source distributed station 14-2, respectively. Furthermore, in the explanation of FIGS. 18 and 19, it is assumed that the source distributed station 14-2 is in a sleep state.

The acquisition unit 211 of the management control device 20b acquires cooperation information from the destination distributed station 14-1 and the source distributed station 14-2 at a predetermined period (steps S601 and S602). The acquisition unit 211 accumulates the acquired cooperation information in the cooperation information accumulation unit 221. When the cooperation information is accumulated in the cooperation information accumulation unit 221, the real-time analysis unit 222b performs optical path switching and sleep control determination (step S603). The optical path switching and sleep control determination in step S603 involves determining whether the second sleep cancellation condition is satisfied. Here, it is assumed that the second sleep cancellation condition is satisfied.

The sleep control unit 232b of the management control device 20b transmits a sleep cancellation notification to the source distributed station 14-2 (step S604). In response to receiving the sleep cancellation notification, the source distributed station 14-2 cancels the sleep state (step S605). After canceling the sleep state, the source distributed station 14-2 transmits a sleep cancellation response notification to the management control device 20b (step S606).

The optical path switching control unit 231b of the management control device 20b transmits switching destination information including information indicating the destination distributed station included in the control information notified from the real-time analysis unit 222b to the transfer device 13 (step S607). The switching destination information here includes information indicating the destination distributed station 14-1 as the destination of the optical path switching.

Furthermore, the optical path switching control unit 231b determines the source distributed station 14-2 as the source of the optical path switching based on the information indicating the source distributed station included in the control information notified from the real-time analysis unit 222b. The optical path switching control unit 231b transmits an optical path switching instruction and a terminal connection change instruction to the determined source distributed station 14-2 (step S608).

The source distributed station 14-2 requests the aggregation station 15 to switch the distributed station 14 to be connected to the terminal 11 associated with the switching of the optical path based on the optical path switching instruction and the terminal connection change instruction transmitted from the management control device 20b (step S609).

In response to the request from the source distributed station 14-2, the aggregation station 15 transmits a terminal context change request to the source distributed station 14-2 (step S610). The source distributed station 14-2 transmits a response to the terminal context change request transmitted from the aggregation station 15 to the aggregation station 15 (step S611). In response to receiving the response to the terminal context change request, the aggregation station 15 transmits a terminal context setup request to the destination distributed station 14-1 (step S612). The destination distributed station 14-1 transmits a response to the terminal context setup request transmitted from the aggregation station 15 to the aggregation station 15 (step S613).

In response to receiving the response to the terminal context setup request, the aggregation station 15 transmits a terminal context change request to the source distributed station 14-2 again (step S614). In response to receiving the terminal context change request transmitted from the aggregation station 15, the source distributed station 14-2 transmits an RRC reconfiguration instruction to the terminal 11 (step S615). The terminal 11 to which the source distributed station 14-2 transmits the RRC reconfiguration instruction is the terminal 11 to be connected to the source wireless station 12-2 connected to the source distributed station 14-2. The terminal 11 performs processing according to the RRC reconfiguration instruction and changes the connection.

After transmitting the RRC reconfiguration instruction, the source distributed station 14-2 transmits a response to the terminal context change request to the aggregation station 15 (step S616). Thereafter, the transfer device 13 instructs the source distributed station 14-2 and the aggregation station 15 to start switching the optical path according to the switching destination information (step S617). In this way, the optical path switching processing is performed (step S618). Specifically, the transfer device 13 switches the optical path between the source wireless station 12-2 and the aggregation station 15 to the optical path between the destination wireless station 12-1 and the aggregation station 15.

After the optical path switching processing is performed, a random access procedure is performed between the terminal 11 and the destination distributed station 14-1 (step S619). The terminal 11 transmits an RRC reconfiguration completion notification indicating the completion of the RRC reconfiguration to the destination distributed station 14-1 via the destination wireless station 12-1 and the transfer device 13 (step S620). When the destination distributed station 14-1 receives the RRC reconfiguration completion notification, the destination distributed station 14-1 transfers the RRC reconfiguration completion notification to the aggregation station 15 as an uplink signal (step S621). When the aggregation station 15 receives the RRC reconfiguration completion notification transferred from the destination distributed station 14-1, the aggregation station 15 transmits a terminal context release instruction to the source distributed station 14-2 (step S622).

The source distributed station 14-2 receives the terminal context release instruction transmitted from the aggregation station 15. The source distributed station 14-2 releases the terminal context based on the received terminal context release instruction. When the release of the terminal context is completed, the source distributed station 14-2 notifies the aggregation station 15 that the release of the terminal context has been completed (step S623). When the release of the terminal context is completed in the source distributed station 14-2, the aggregation station 15 transmits a connection change completion notification to the management control device 20b (step S624).

According to the mobile NW system 100b in the second embodiment configured as described above, it is possible to obtain the same effects as those in the first embodiment.

### First Modification Example of Second Embodiment

The mobile NW system 100b may be modified as shown in the first modification example of the first embodiment and the second modification example of the first embodiment.

### Second Modification Example of Second Embodiment

The mobile NW system 100b may be configured such that the transfer device 13 performs the optical path switching control processing and the sleep control processing as shown in the third modification example of the first embodiment. When configured in this way, the transfer device 13 included in the mobile NW system 100b includes the control unit 23b included in the management control device 20b, and the management control device 20b does not include the control unit 23b.

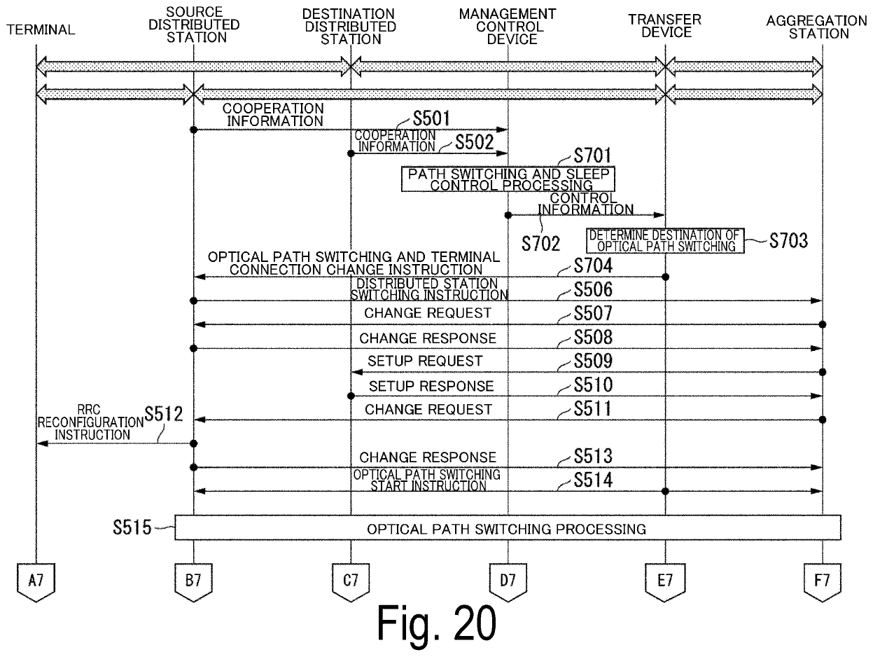

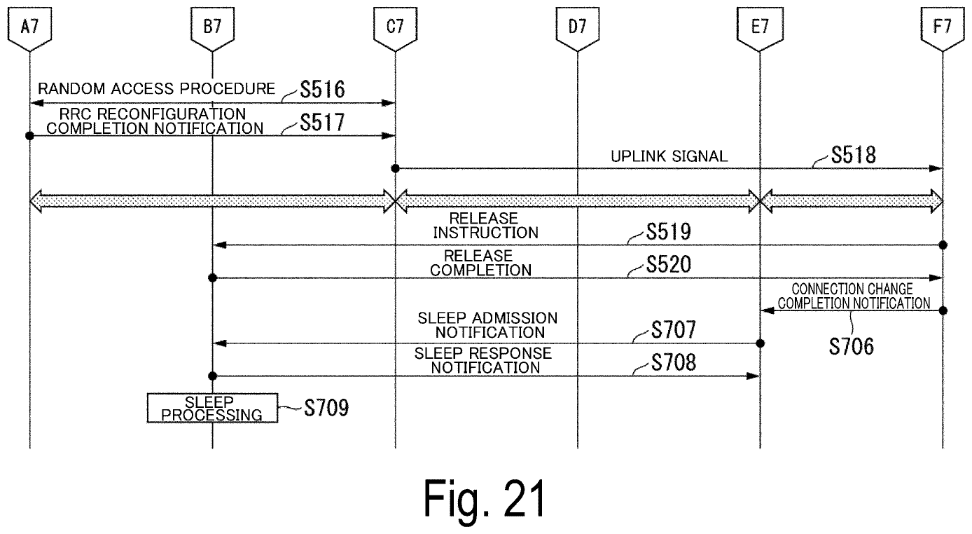

FIGS. 20 and 21 are sequence diagrams showing an example of a detailed flow of the sleep processing executed by the mobile NW system 100b in the second modification example of the second embodiment. In FIGS. 20 and 21, the same processing steps as those in FIGS. 16 and 17 are denoted by the same reference numerals as those in FIGS. 16 and 17, and the description thereof will be omitted.

After the processing from step S501 to step S502 is executed, when the cooperation information is accumulated in the cooperation information accumulation unit 221, the real-time analysis unit 222b performs optical path switching and sleep control determination (step S701). The optical path switching and sleep control determination in step S701 involves determining whether the second switching condition is satisfied. Here, it is assumed that the second switching condition is satisfied. If the second switching condition is satisfied, the real-time analysis unit 222b transmits control information to the transfer device 13 (step S702). The transfer device 13 receives the control information transmitted from the management control device 20b.

The optical path switching control unit 231b of the transfer device 13 determines the destination distributed station 14-1 as the destination of the optical path switching based on the information indicating the destination distributed station included in the received control information (step S703). Furthermore, the optical path switching control unit 231b determines the source distributed station 14-2 as the source of the optical path switching based on the information indicating the source distributed station included in the received control information. The optical path switching control unit 231b transmits an optical path switching instruction and a terminal connection change instruction to the determined source distributed station 14-2 (step S704). Subsequently, processing from step S506 to step S520 is executed.

After the processing of step S520 is executed, when the release of the terminal context is completed in the source distributed station 14-2, the aggregation station 15 transmits a connection change completion notification to the transfer device 13 (step S706). When the connection change completion notification is received, the sleep control unit 232b of the transfer device 13 transmits a sleep admission notification to the source distributed station 14-2 (step S707). When the source distributed station 14-2 receives the sleep admission notification from the transfer device 13, the source distributed station 14-2 transmits a sleep response notification to the transfer device 13 (step S708). After transmitting the sleep response notification, the source distributed station 14-2 transitions to a sleep state (step S709).

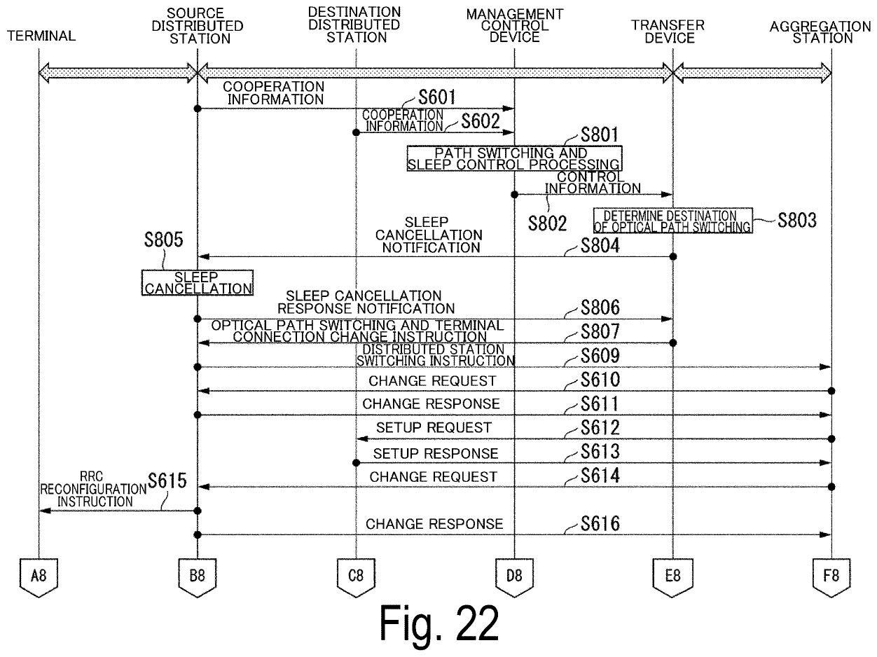

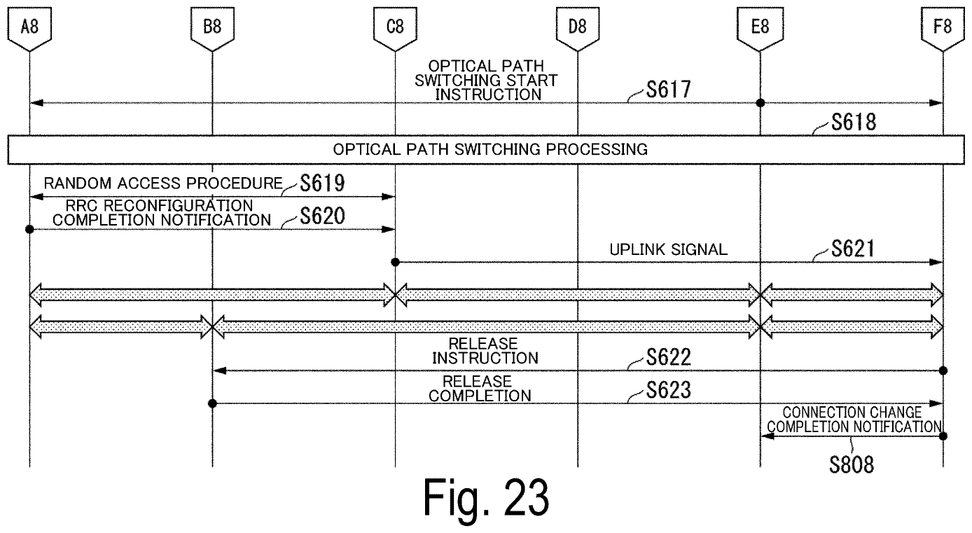

FIGS. 22 and 23 are sequence diagrams showing an example of a detailed flow of sleep cancellation processing executed by the mobile NW system 100b in the third modification example of the second embodiment. In FIGS. 22 and 23, the same processing steps as those in FIGS. 18 and 19 are denoted by the same reference numerals as those in FIGS. 18 and 19, and the description thereof will be omitted. In the description of FIGS. 22 and 23, it is assumed that the source distributed station 14-2 is in a sleep state.

After the processing from step S601 to step S602 is executed, when the cooperation information is accumulated in the cooperation information accumulation unit 221, the real-time analysis unit 222b performs optical path switching and sleep control determination (step S801). The optical path switching and sleep control determination in step S801 involves determining whether the second sleep cancellation condition is satisfied. Here, it is assumed that the second sleep cancellation condition is satisfied. When the second sleep cancellation condition is satisfied, the real-time analysis unit 222b transmits control information to the transfer device 13 (step S802). The transfer device 13 receives the control information transmitted from the management control device 20b.

The optical path switching control unit 231b of the transfer device 13 determines the destination distributed station 14-1 as the destination of the optical path switching based on the information indicating the destination distributed station included in the received control information (step S803). The sleep control unit 232b transmits a sleep cancellation notification to the source distributed station 14-2 (step S804). The source distributed station 14-2 cancels the sleep state in response to receiving the sleep cancellation notification (step S805). After canceling the sleep state, the source distributed station 14-2 transmits a sleep cancellation response notification to the transfer device 13 (step S806).

The optical path switching control unit 231b of the transfer device 13 determines the source distributed station 14-2 as the source of optical path switching based on the information indicating the source distributed station included in the received control information. The optical path switching control unit 231b transmits an optical path switching instruction and a terminal connection change instruction to the determined source distributed station 14-2 (step S807). Subsequently, processing from step S609 to step S623 is executed. When the release of the terminal context is completed in the source distributed station 14-2, the aggregation station 15 transmits a connection change completion notification to the transfer device 13 (step S808).

### Third Embodiment

In the third embodiment, a configuration including a base station in which the wireless station 12, the distributed station 14, and the aggregation station 15 are integrated will be described.

### Outline of Third Embodiment

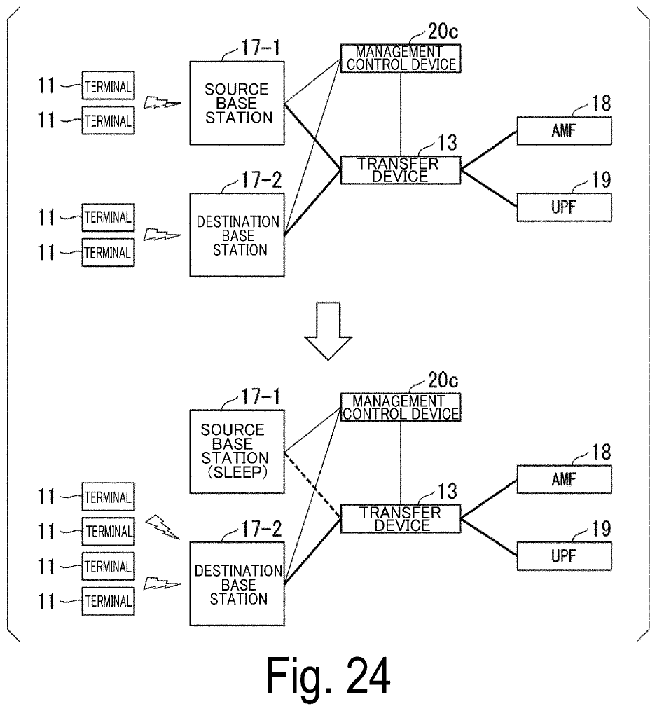

FIG. 24 is a diagram for explaining an outline of the processing of the mobile NW system in the third embodiment. First, the overall configuration of the mobile NW system in the third embodiment will be described. The mobile NW system in the third embodiment is an example of a communication system. The mobile NW system in the third embodiment is, for example, 5G. The mobile NW system in the third embodiment includes a plurality of base stations 17, a transfer device 13, an AMF (Access and Mobility management Function) 18, a UPF 19, and a management control device 20c. Note that in FIG. 24, the source base station 17-1 and the destination base station 17-2 are shown as the base stations 17.

The source base station 17-1 and the transfer device 13, the destination base station 17-2 and the transfer device 13, the transfer device 13 and the AMF 18, and the transfer device 13 and the UPF 19 are connected by optical fibers that transmit optical signals. The transfer device 13 and the management control device 20c, the source base station 17-1 and the management control device 20c, and the destination base station 17-2 and the management control device 20c are connected by optical fibers or electric lines that transmit electric signals.

In the example shown in FIG. 24, one source base station 17-1, one destination base station 17-2, one AMF 18, and one UPF 19 are shown. Note that a plurality of transfer devices 13 may be provided, but the following description will be given with the example of one transfer device. In the following description, when there is no particular distinction between the source base station 17-1 and the destination base station 17-2, they will simply be referred to as base stations 17.

The base station 17 is a device in which the wireless station 12, the distributed station 14, and the aggregation station 15 are integrated. The base station 17 transmits signals received from each terminal 11 to the AMF 18 or the UPF 19. The base station 17 transmits signals transmitted from the AMF 18 or the UPF 19 to each terminal 11. The base station 17 transmits cooperation information to the management control device 20c.

When a new terminal is connected to the sleep target base station 17 or a terminal connection is changed from another base station, the AMF 18 or the management control device 20c may instruct the source base station 17-1 to reject the new terminal connection after the source base station 17-1 receives an optical path switching instruction and an instruction to change connection of the terminal 11 from the management control device 20c.

The AMF 18 is a node of the control plane in the 5G core network. The AMF 18 manages terminals such as the registration of the terminal 11 and the location information of the terminal 11. The AMF 18 receives an optical path switch request from the base station 17 and changes the connection path of the terminal 11. The optical path switch request is a signal for requesting a change of the connection path of the terminal 11.

The UPF 19 is a node of the user plane in the 5G core network. The UPF 19 is a relay device that performs transmission and reception processing of user data. For example, the UPF 19 performs transmission and reception processing of user data between an external network and the base station 17.

The upper diagram of FIG. 24 shows the connection state of the mobile NW system before optical path switching, and the lower diagram of FIG. 24 shows the connection state of the mobile NW system after optical path switching. The upper diagram of FIG. 24 shows an example in which each base station 17 is connected to the AMF 18 and the UPF 19 via the transfer device 13.

The management control device 20c determines whether to perform optical path switching control processing based on the cooperation information collected from each base station 17. The cooperation information in the third embodiment includes, for example, traffic information that the base station 17 receives from the UPF in the downlink and traffic information that the base station 17 sends to the UPF in the uplink. The management control device 20c compares a switching determination threshold stored in advance with the traffic volume indicated by the traffic information included in the collected cooperation information. When the management control device 20c determines to perform the optical path switching control processing, the management control device 20c transmits switching destination information to the transfer device 13. Furthermore, the management control device 20c transmits an optical path switching instruction to the source base station 17-1 to be subjected to the optical path switching.

For example, it is assumed that the management control device 20c selects the source base station 17-1 as the target of the optical path switching. In this case, the management control device 20c transmits an optical path switching instruction to the source base station 17-1. According to the optical path switching instruction transmitted from the management control device 20c, the source base station 17-1 requests the AMF 18 to change the connection path of the terminal 11 associated with the switching of the optical path. For example, the source base station 17-1 transmits an optical path switch request to the AMF 18. The AMF 18 performs processing related to changing the connection path of the terminal 11 in response to the optical path switch request transmitted from the source base station 17-1.

When the processing related to changing the connection path of the terminal 11 is completed, the management control device 20c transmits a sleep admission notification to the source base station 17-1. As a result, the source base station 17-1 transitions to a sleep state.

The lower diagram of FIG. 24 shows an example in which the terminal 11 connected to the source base station 17-1 connects to the destination base station 17-2 and the source base station 17-1 transitions to a sleep state. In this way, in the mobile NW system in the third embodiment, after the change of the connection path of the terminal 11 is completed, the optical path between the base station 17 and the transfer device 13 is switched.

### Details of Third Embodiment

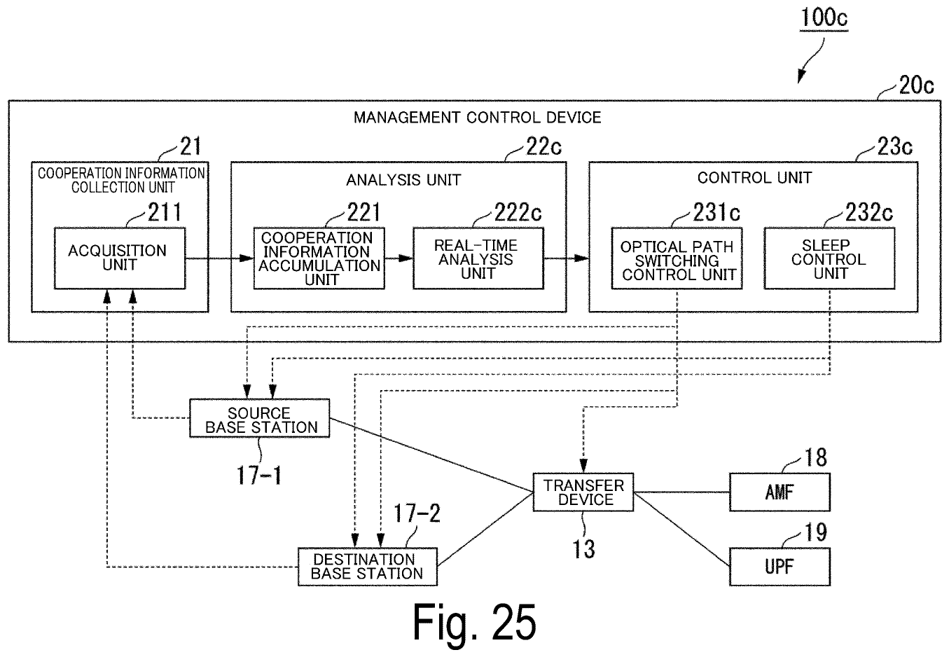

FIG. 25 is a diagram showing a configuration example of a mobile NW system 100c in the third embodiment. The mobile NW system 100c in the third embodiment includes a plurality of base stations 17, a transfer device 13, an AMF 18, a UPF 19, and a management control device 20c. In the following description, a case in which the mobile NW system 100c includes two wireless stations 12 and two base stations 17 will be used as an example. The base station 17, the transfer device 13, the AMF 18, and the UPF 19 are not described here because they have been described in FIG. 24. The management control device 20c includes a cooperation information collection unit 21, an analysis unit 22c, and a control unit 23c.

The analysis unit 22c includes a cooperation information accumulation unit 221 and a real-time analysis unit 222c. The real-time analysis unit 222c analyzes the state of communication between each base station 17 and the terminal 11 based on the cooperation information. Specifically, the real-time analysis unit 222c determines whether optical path switching and sleep control are necessary based on the cooperation information.

When determining whether optical path switching and sleep control are necessary, the real-time analysis unit 222c compares a switching determination threshold stored in advance with the traffic volume indicated by the traffic information included in the collected cooperation information. The real-time analysis unit 222c stores a switching determination threshold for each base station 17. The switching determination threshold may be the same for all base stations 17, or may be different for only some of the base stations 17.

The real-time analysis unit 222c determines whether a third switching condition is satisfied as a result of the comparison. The third switching condition is a condition indicating that switching of an optical path between the base station 17 and the transfer device 13 is necessary. The third switching condition is, for example, that the switching determination threshold for the source base station is greater than the traffic volume obtained from the source base station, and that the switching determination threshold for the destination base station is greater than the traffic volume obtained from the destination base station.

The real-time analysis unit 222c determines to perform optical path switching control processing when the third switching condition is satisfied. On the other hand, the real-time analysis unit 222c determines not to perform the optical path switching control processing when the third switching condition is not satisfied. When the real-time analysis unit 222c determines to perform the optical path switching control processing, the real-time analysis unit 222c notifies the control unit 23c of control information including information indicating the source base station, information indicating the destination base station, and information indicating the base station 17 to be subjected to sleep control.

Furthermore, the real-time analysis unit 222c determines whether the third sleep cancellation condition is satisfied as a result of the comparison. The third sleep cancellation condition is a condition indicating that the sleep of the sleeping base station 17 is to be canceled. The third sleep cancellation condition is, for example, that the traffic volume of the base station 17 that has become the switching destination under the third switching condition is greater than the switching determination threshold for the base station 17 that has become the switching destination under the third switching condition. In this way, the third sleep cancellation condition is a condition for canceling the sleep state of the sleeping base station 17 when the traffic of the base station 17 that has become the switching destination under the third switching condition increases.

The real-time analysis unit 222c determines to perform the optical path switching control processing when the third sleep cancellation condition is satisfied. On the other hand, the real-time analysis unit 222c determines not to perform the optical path switching control processing when the third sleep cancellation condition is not satisfied. When the real-time analysis unit 222c determines to perform the optical path switching control processing, the real-time analysis unit 222c notifies the control unit 23c of control information including information indicating the source base station, information indicating the destination base station, and information indicating the base station 17 to be subjected to sleep control.

The control unit 23c includes an optical path switching control unit 231c and a sleep control unit 232c. The optical path switching control unit 231c determines the destination base station based on the analysis result from the real-time analysis unit 222c. The optical path switching control unit 231c transmits switching destination information including information indicating the determined base station 17, which is the destination of the optical path switching, to the transfer device 13. As a result, the optical path switching control unit 231c instructs the transfer device 13 to switch the optical path.

Furthermore, the optical path switching control unit 231c determines the source base station based on the analysis result from the real-time analysis unit 222c. The optical path switching control unit 231c transmits an optical path switching instruction and a terminal connection change instruction to the determined base station 17 that is the source of optical path switching.

The sleep control unit 232c causes the base station 17 to be subjected to sleep control to execute sleep or cancel sleep based on the analysis result from the real-time analysis unit 222c.

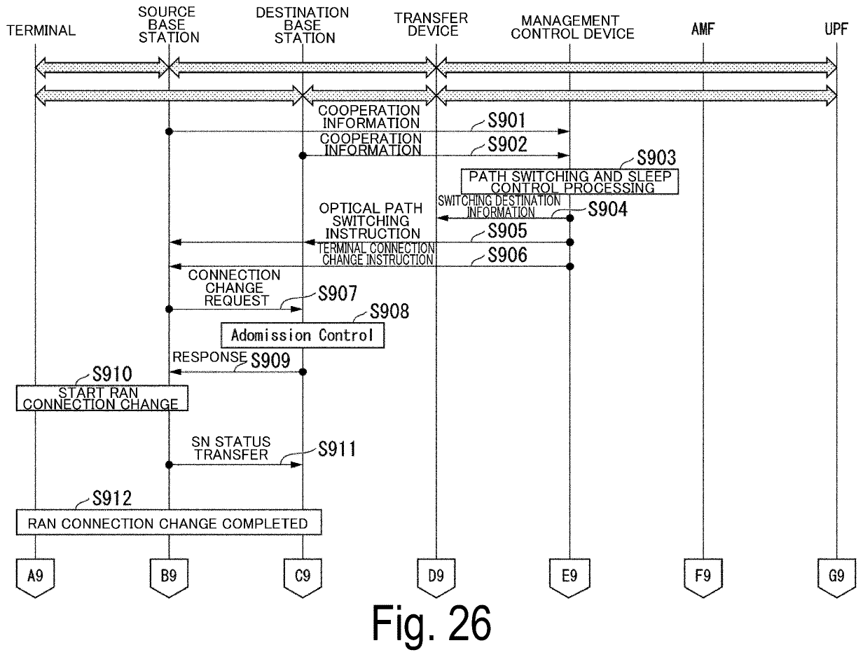

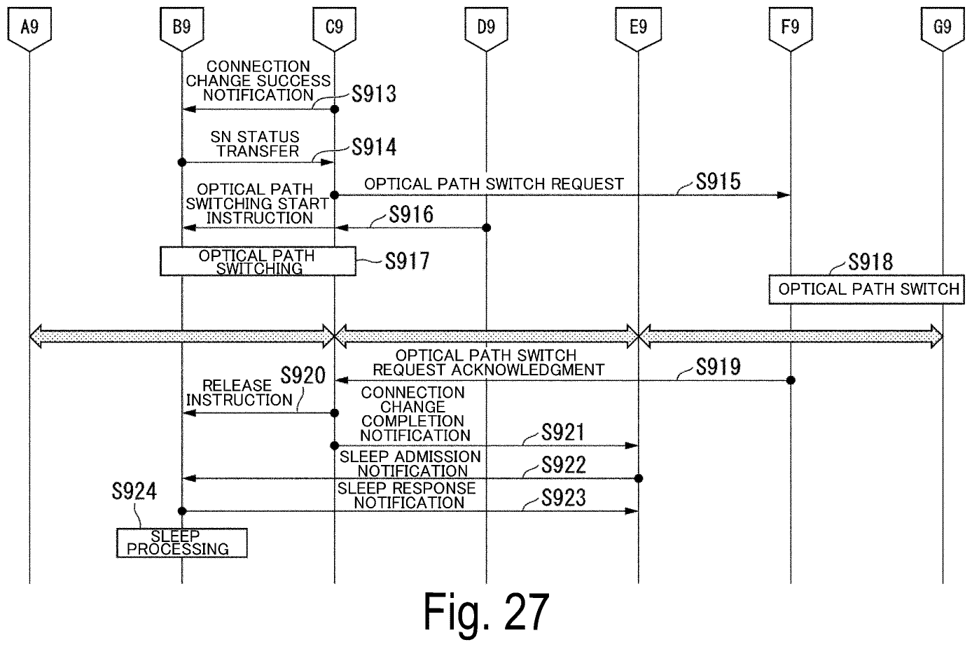

FIGS. 26 and 27 are sequence diagrams showing an example of a detailed flow of the sleep processing executed by the mobile NW system 100c in the third embodiment. The acquisition unit 211 of the management control device 20c acquires cooperation information from the source base station 17-1 and the destination base station 17-2 at a predetermined period (steps S901 and S902). The acquisition unit 211 accumulates the acquired cooperation information in the cooperation information accumulation unit 221. When the cooperation information is accumulated in the cooperation information accumulation unit 221, the real-time analysis unit 222c performs optical path switching and sleep control determination (step S903).

The optical path switching and sleep control determination in step S903 involves determining whether the third switching condition is satisfied. Here, it is assumed that the third switching condition is satisfied. When the third switching condition is satisfied, the real-time analysis unit 222c notifies the control unit 23c of the control information.

The optical path switching control unit 231c transmits, to the transfer device 13, switching destination information including information indicating the destination base station included in the control information notified from the real-time analysis unit 222c (step S904). Here, the switching destination information includes information indicating the destination base station 17-2 as the destination of the optical path switching. Furthermore, the optical path switching control unit 231c transmits an optical path switching instruction to the source base station 17-1 and the destination base station 17-2 (step S905). The optical path switching control unit 231c transmits a terminal connection change instruction to the source base station 17-1 (step S906).

The source base station 17-1 sends, to the destination base station 17-2, a connection request for the terminal 11 associated with the switching of the optical path based on the optical path switching instruction and the terminal connection change instruction transmitted from the management control device 20c (step S907). The destination base station 17-2 determines whether to accept the connection request in response to the connection request from the source base station 17-1 (step S908). Here, it is assumed that the destination base station 17-2 has determined to accept the connection request. The destination base station 17-2 then transmits a response to the source base station 17-1, indicating that the connection request is accepted (step S909).

The source base station 17-1 changes the connection of the radio access network (RAN) between the terminal 11 and the destination base station 17-2 according to the response that the connection request from the destination base station 17-2 is accepted (step S910). The source base station 17-1 transfers the SN status to the destination base station 17-2 (step S911). The SN status transfer processing in step S911 represents processing of sending a message including information such as up to which packet number the source base station 17-1 has received and transmitted packets, and that the destination base station 17-2 will transmit and receive data starting with this packet number. In this way, the connection change of the radio access network between the terminal 11 and the destination base station 17-2 is completed (step S912).

The destination base station 17-2 transmits a notification to the source base station 17-1, indicating that the connection change of the terminal 11 has been successful (step S913). The source base station 17-1 transfers the SN status to the destination base station 17-2 (step S914). The destination base station 17-2 transmits an optical path switch request to the AMF 18 via the transfer device 13 (step S915). The transfer device 13 instructs the source base station 17-1 and the destination base station 17-2 to start switching the optical path (step S916). The source base station 17-1 and the destination base station 17-2 switch the optical path in response to the instruction from the transfer device 13 (step S917). The AMF 18 switches the optical path in response to the optical path switch request from the destination base station 17-2 (step S918).

When the optical path switching is completed, the AMF 18 transmits an optical path switch request acknowledgment to the destination base station 17-2 (step S919). The optical path switch request acknowledgment is a notification indicating that the optical path switch request has been received. When the destination base station 17-2 receives the optical path switch request acknowledgment, the destination base station 17-2 transmits a terminal context release instruction to the source base station 17-1 (step S920).

The source base station 17-1 receives the terminal context release instruction transmitted from the destination base station 17-2. The source base station 17-1 releases the terminal context based on the received terminal context release instruction. The destination base station 17-2 transmits a connection change completion notification to the management control device 20c (step S921).

When the connection change completion notification is received, the sleep control unit 232c of the management control device 20c transmits a sleep admission notification to the source base station 17-1 (step S922). When the source base station 17-1 receives the sleep admission notification from the management control device 20c, the source base station 17-1 transmits a sleep response notification to the management control device 20c (step S923). After transmitting the sleep response notification, the source base station 17-1 transitions to a sleep state (step S924).

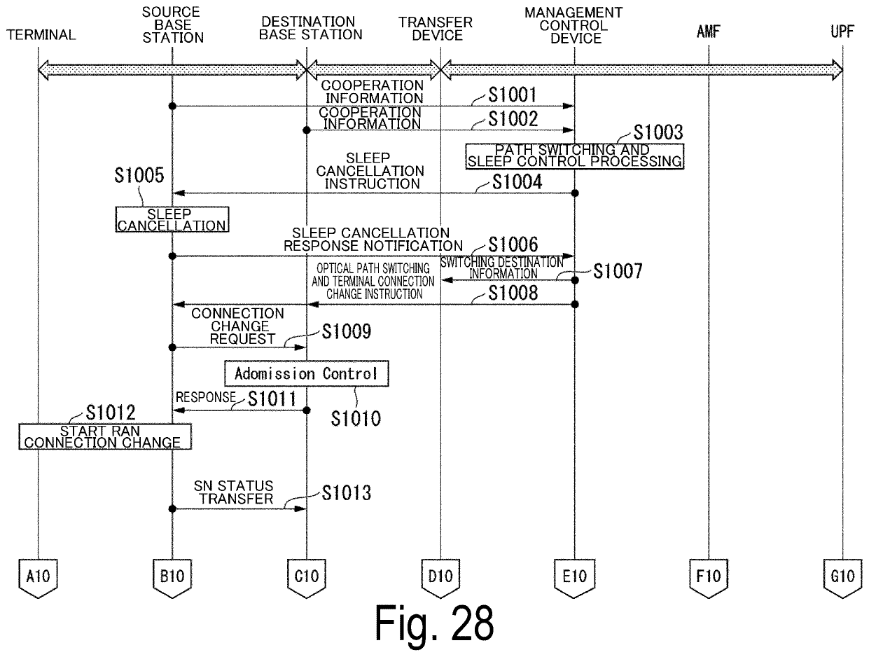

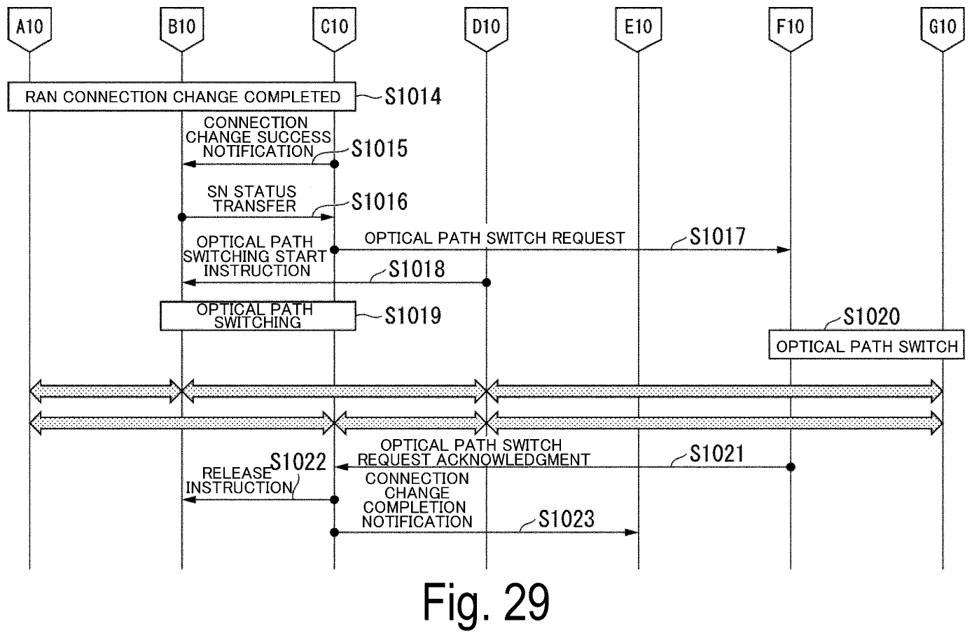

FIGS. 28 and 29 are sequence diagrams showing an example of a detailed flow of sleep cancellation processing executed by the mobile NW system 100c in the third embodiment. In the explanation of FIGS. 28 and 29, it is assumed that the source base station 17-1 is in a sleep state.

The acquisition unit 211 of the management control device 20c acquires cooperation information from the source base station 17-1 and the destination base station 17-2 at a predetermined period (steps S1001 and S1002). The acquisition unit 211 accumulates the acquired cooperation information in the cooperation information accumulation unit 221.

When the cooperation information is accumulated in the cooperation information accumulation unit 221, the real-time analysis unit 222c performs optical path switching and sleep control determination (step S1003). The optical path switching and sleep control determination in step S1003 involves determining whether the third sleep cancellation condition is satisfied. Here, it is assumed that the third sleep cancellation condition is satisfied.

The sleep control unit 232c of the management control device 20c transmits a sleep cancellation notification to the source base station 17-1 (step S1004). In response to receiving the sleep cancellation notification, the source base station 17-1 cancels the sleep state (step S1005). After canceling the sleep state, the source base station 17-1 transmits a sleep cancellation response notification to the management control device 20c (step S1006).

After receiving the sleep cancellation response notification, the optical path switching control unit 231c of the management control device 20c transmits switching destination information including information indicating the destination base station included in the control information notified from the real-time analysis unit 222c to the transfer device 13 (step S1007). Here, the switching destination information includes information indicating the destination base station 17-2 as the destination of the optical path switching. Furthermore, the optical path switching control unit 231c transmits an optical path switching instruction and a terminal connection change instruction to the source base station 17-1 and the destination base station 17-2 (step S1008).

The source base station 17-1 sends, to the destination base station 17-2, a connection request for the terminal 11 associated with the switching of the optical path based on the optical path switching instruction and the terminal connection change instruction transmitted from the management control device 20c (step S1009). The destination base station 17-2 determines whether to accept the connection request in response to the connection request from the source base station 17-1 (step S1010). Here, it is assumed that the destination base station 17-2 has determined to accept the connection request. The destination base station 17-2 then transmits a response to the source base station 17-1, indicating that the connection request is accepted (step S1011).

The source base station 17-1 changes the connection of the wireless access network between the terminal 11 and the destination base station 17-2 according to the response from the destination base station 17-2, indicating that the connection request is accepted (step S1012). The source base station 17-1 transfers the SN status to the destination base station 17-2 (step S1013). In this way, the change of connection of the wireless access network between the terminal 11 and the destination base station 17-2 is completed (step S1014).

The destination base station 17-2 transmits a notification to the source base station 17-1, indicating that the connection change of the terminal 11 has been successful (step S1015).

The source base station 17-1 transfers the SN status to the destination base station 17-2 (step S1016). The destination base station 17-2 transmits an optical path switch request to the AMF 18 via the transfer device 13 (step S1017). The transfer device 13 instructs the source base station 17-1 and the destination base station 17-2 to start switching the optical path (step S1018). The source base station 17-1 and the destination base station 17-2 switch the optical path in response to the instruction from the transfer device 13 (step S1019). The AMF 18 switches the optical path in response to the optical path switch request from the destination base station 17-2 (step S1020).

When the optical path switching is completed, the AMF 18 transmits an optical path switch request acknowledgment to the destination base station 17-2 (step S1021). When the destination base station 17-2 receives the optical path switch request acknowledgment, the destination base station 17-2 transmits a terminal context release instruction to the source base station 17-1 (step S1022). The source base station 17-1 receives the terminal context release instruction transmitted from the destination base station 17-2. The source base station 17-1 releases the terminal context based on the received terminal context release instruction. The destination base station 17-2 transmits a connection change completion notification to the management control device 20c (step S1023).

According to the mobile NW system 100c in the second embodiment configured as described above, it is possible to obtain the same effects as those of the first embodiment.

### First Modification Example of Third Embodiment

The mobile NW system 100c may be modified as shown in the first modification example of the first embodiment and the second modification example of the first embodiment.

### Second Modification Example of Third Embodiment

The mobile NW system 100c may be configured such that the transfer device 13 performs the optical path switching control processing and the sleep control processing as shown in the third modification example of the first embodiment. When configured in this way, the transfer device 13 included in the mobile NW system 100c includes the control unit 23b included in the management control device 20c, and the management control device 20c does not include the control unit 23b.

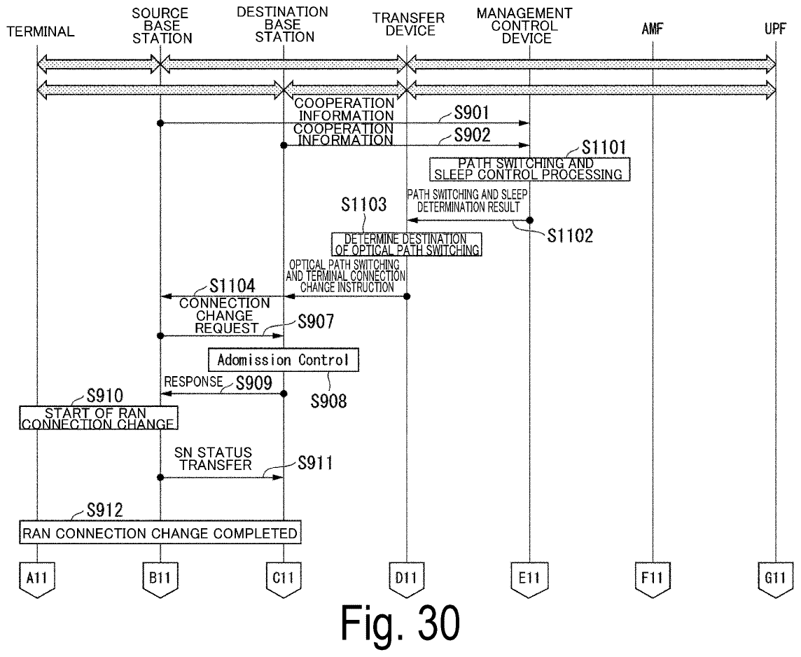

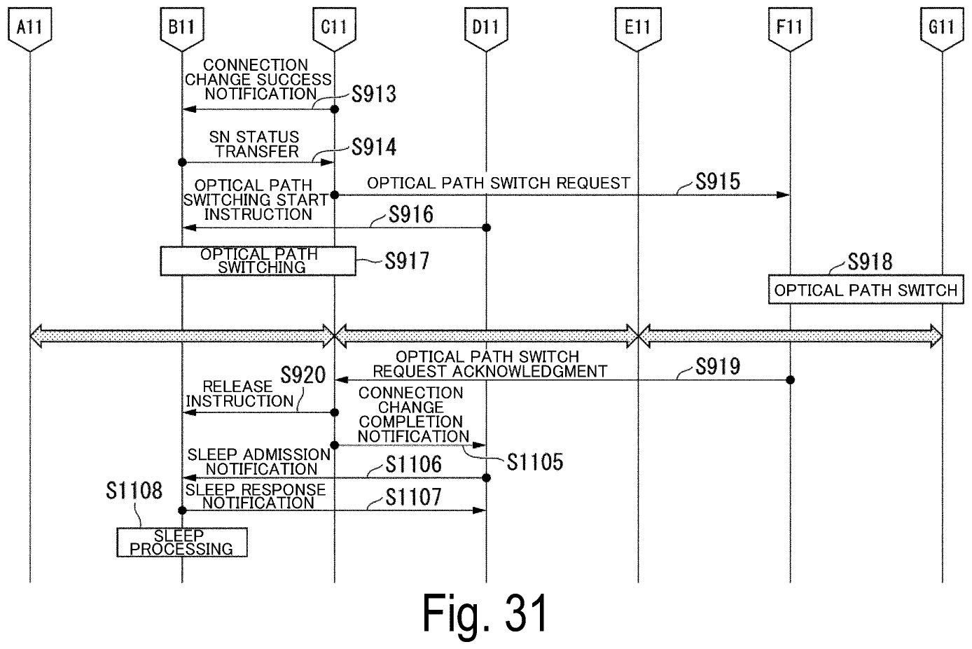

FIGS. 30 and 31 are sequence diagrams showing an example of a detailed flow of the sleep processing executed by the mobile NW system 100c in the second modification example of the third embodiment. In FIGS. 30 and 31, the same processing steps as those in FIGS. 26 and 27 are denoted by the same reference numerals as those in FIGS. 26 and 27, and the description thereof will be omitted.

After the processing from step S901 to step S902 is executed, when the cooperation information is accumulated in the cooperation information accumulation unit 221, the real-time analysis unit 222c performs optical path switching and sleep control determination (step S1101). The optical path switching and sleep control determination in step S1101 involves determining whether the third switching condition is satisfied. Here, it is assumed that the third switching condition is satisfied. When the third switching condition is satisfied, the real-time analysis unit 222c transmits control information to the transfer device 13 (step S1102). The transfer device 13 receives the control information transmitted from the management control device 20c.

The optical path switching control unit 231c of the transfer device 13 determines the destination base station 17-2 as the destination of the optical path switching based on the information indicating the destination distributed station included in the received control information (step S1103). Furthermore, the optical path switching control unit 231c transmits an optical path switching instruction and a terminal connection change instruction to the source base station 17-1 and the destination base station 17-2 (step S1104). Subsequently, processing from step S907 to step S920 is executed.

After the processing of step S920 is executed, the destination base station 17-2 transmits a connection change completion notification to the transfer device 13 (step S1105).

When the sleep control unit 232c of the transfer device 13 receives the connection change completion notification, the sleep control unit 232c transmits a sleep admission notification to the source base station 17-1 (step S1106). When the source base station 17-1 receives the sleep admission notification from the transfer device 13, the source base station 17-1 transmits a sleep response notification to the transfer device 13 (step S1107). After transmitting the sleep response notification, the source base station 17-1 transitions to a sleep state (step S1108).

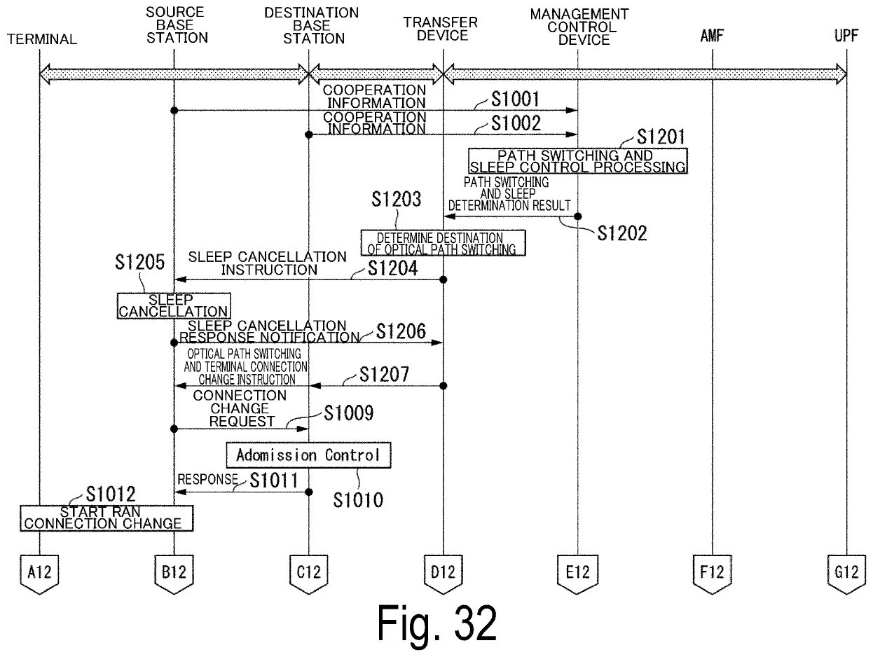

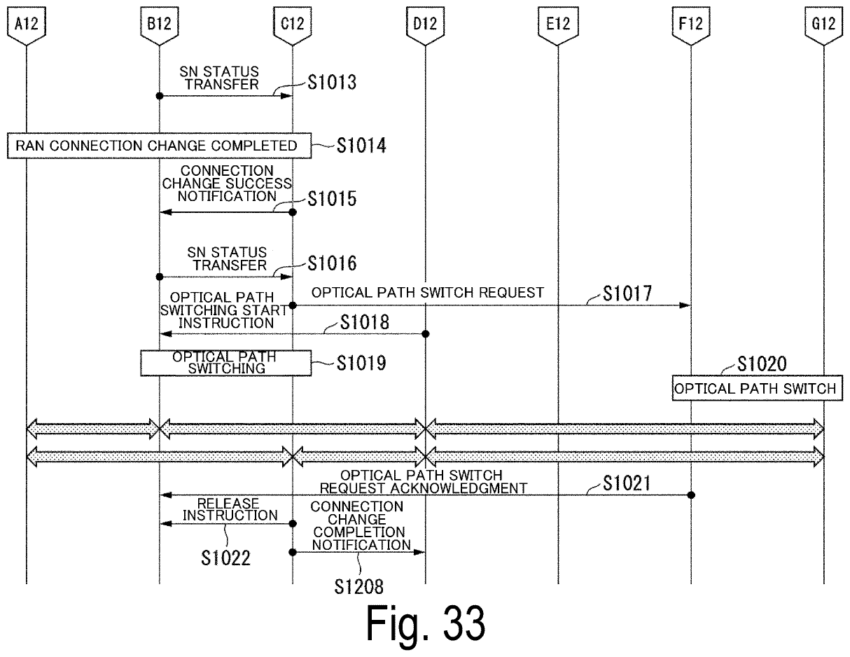

FIGS. 32 and 33 are sequence diagrams showing an example of a detailed flow of sleep cancellation processing executed by the mobile NW system 100c in the third modification example of the third embodiment. In FIGS. 32 and 33, the same processing steps as those in FIGS. 28 and 29 are denoted by the same reference numerals as those in FIGS. 28 and 29, and the description thereof will be omitted. In the description of FIGS. 32 and 33, it is assumed that the source base station 17-1 is in a sleep state.

After the processing from step S1001 to step S1002 is executed, the real-time analysis unit 222c performs optical path switching and sleep control determination when the cooperation information is accumulated in the cooperation information accumulation unit 221 (step S1201). The optical path switching and sleep control determination in step S1201 involves determining whether the third sleep cancellation condition is satisfied. Here, it is assumed that the third sleep cancellation condition is satisfied. When the third sleep cancellation condition is satisfied, the real-time analysis unit 222c transmits control information to the transfer device 13 (step S1202). The transfer device 13 receives the control information transmitted from the management control device 20c.

The optical path switching control unit 231c of the transfer device 13 determines the destination base station 17-2 as the destination of the optical path switching based on the information indicating the destination distributed station included in the received control information (step S1203). The sleep control unit 232c transmits a sleep cancellation notification to the source base station 17-1 (step S1204). The source base station 17-1 cancels the sleep state in response to receiving the sleep cancellation notification (step S1205). After canceling the sleep state, the source base station 17-1 transmits a sleep cancellation response notification to the transfer device 13 (step S1206).

The optical path switching control unit 231c of the transfer device 13 transmits an optical path switching instruction and a terminal connection change instruction to the source base station 17-1 and the destination base station 17-2 (step S1207). Subsequently, processing from step S1009 to step S1022 is executed. When the release of the terminal context is completed in the source base station 17-1, the destination base station 17-2 transmits a connection change completion notification to the transfer device 13 (step S1208).

At least some or all of the functional units of the management control devices 20, 20a, 20b, and 20c, or some or all of the functional units of the transfer devices 13 and 13a are realized as software by a processor such as a CPU (Central Processing Unit) executing a program stored in a storage device having a non-volatile recording medium (non-transitory recording medium) and a storage unit. The program may be recorded on a computer-readable non-transitory recording medium. The computer-readable non-transitory recording medium is a non-temporary recording medium such as a portable medium such as a flexible disk, a magneto-optical disc, a read only memory (ROM), or a compact disc read only memory (CD-ROM), or a storage apparatus such as a hard disk built into a computer system.

At least some or all of the functional units of the management control devices 20, 20a, 20b, and 20c, or some or all of the functional units of the transfer devices 13 and 13a may be realized using hardware including electronic circuits (electronic circuits or circuitry) using, for example, a large-scale integrated circuit (LSI), an application-specific integrated circuit (ASIC), a programmable logic device (PLD), or a field programmable gate array (FPGA).

Although the embodiment of the present invention has been described in detail with reference to the drawings, a specific configuration is not limited to this embodiment and design within the scope of the gist of the present invention, and the like are included.

### Industrial Applicability

The present invention can be applied to optical communication systems such as optical access systems.

### Reference Signs List

11 Terminal,
12, 12-1 to 12-4 Wireless station,
13, 13a Transfer device,
14, 14-1 to 14-2 Distributed station,
15 Aggregation station,
16 Core device,
17-1 Source base station,
17-2 Destination base station,
18 AMF,
19 UPF,
20, 20a, 20b, 20c Management control device,
21, 21c, 21d Cooperation information collection unit,
22, 22b, 22c Analysis unit,
23, 23b, 23c Control unit,
30 Optical transmission management control device,
40 Wireless transmission management control device,
100, 100a, 100c, 110, 120 Mobile NW system,
211 Acquisition unit,
221 Cooperation information accumulation unit,
222, 222b, 222c Real-time analysis unit,
231, 231b, 231c Optical path switching control unit,
232, 232b, 232c Sleep control unit

1. A management control device comprising:
a information collector configured to acquire, at a predetermined period, information indicating a state of communication with one or more terminals from one or more base stations that perform wireless communication with the one or more terminals;
an analyzer configured to determine whether switching of an optical path is necessary based on the information;
an optical path switching controller configured to transmit switching destination information including information on a destination of optical path switching to a transfer device that switches the optical path connected to the one or more base stations when it is determined that switching of the optical path is necessary, and instruct a base station that is a source of the optical path switching to change a connection of a terminal associated with switching of the optical path; and
a sleep controller configured to transition the base station that is the source of the optical path switching to a sleep state after the optical path is switched and the connection of the terminal is changed.

2. The management control device according to claim 1, wherein
the one or more base stations are a wireless station having a wireless communication function and a distributed station having a signal processing function,
the transfer device is provided between the wireless station and the distributed station,
the information is traffic volume information, and
the analyzer determines whether switching of the optical path is necessary based on a traffic volume indicated by the traffic volume information and a threshold for determining that switching of the optical path is necessary.

3. The management control device according to claim 1, wherein
the one or more base stations are a wireless station having a wireless communication function and a distributed station having a signal processing function,
the wireless station is directly connected to the distributed station,
the transfer device is provided between the distributed station and an aggregation station that aggregates uplink signals transmitted by the distributed station,
the information is traffic volume information received by the distributed station from the aggregation station in downlink and traffic volume information transmitted by the distributed station to the aggregation station in uplink, and
the analyzer determines whether switching of the optical path is necessary based on a traffic volume indicated by the traffic volume information and a threshold for determining that switching of the optical path is necessary.

4. The management control device according to claim 1, wherein
the one or more base stations are a device that includes, in the same housing, a wireless station having a wireless communication function, a distributed station having a signal processing function, and an aggregation station that aggregates uplink signals transmitted by the distributed station,
the transfer device is provided between the one or more base stations and a node device that performs transmission and reception processing of user data,
the information is information on the traffic volume received by the one or more base stations from the node device in the downlink, and is information on the traffic volume transmitted by the one or more base stations to the node device in the uplink, and
the analyzer determines whether switching of the optical path is necessary based on the volume of traffic indicated by the traffic volume information and a threshold for determining that switching of the optical path is necessary.

5. A communication system comprising:
a information collector configured to acquire, at a predetermined period, information indicating a state of communication with one or more terminals from one or more base stations that perform wireless communication with the one or more terminals;
an analyzer configured to determine whether switching of an optical path is necessary based on the information;
an optical path switching controller configured to transmit switching destination information including information on a switching destination of an optical path to a transfer device that switches the optical path connected to the one or more base stations when it is determined that switching of the optical path is necessary, and instruct a base station that is a source of the optical path switching to change a connection of a terminal associated with switching of the optical path; and
a sleep controller configured to transition the base station that is the source of the optical path switching to a sleep state after the optical path is switched and the connection of the terminal is changed.

6. The communication system according to claim 5, wherein
the optical path switching controller is provided in either a transfer device, a management control device, or an optical transmission management control device,
the transfer device switches an optical path between the one or more base stations and another device,
the management control device manages the system, and
the optical transmission management control device controls at least an optical transmission section between the transfer device and the one or more base stations.

7. The communication system according to claim 5, wherein
the sleep controller is provided in either a transfer device, a management control device, or a wireless transmission management control device,
the transfer device switches an optical path between the one or more base stations and another device,
the management control device manages the system, and
the wireless transmission management control device controls a wireless transmission section between the one or more terminals and the one or more base stations.

8. A control method comprising:
acquiring, at a predetermined period, information indicating a state of communication with one or more terminals from one or more base stations that perform wireless communication with the one or more terminals;
determining whether switching of an optical path is necessary based on the information;
transmitting switching destination information including information on a destination of optical path switching to a transfer device that switches the optical path connected to the one or more base stations when it is determined that switching of the optical path is necessary;
instructing a base station that is a source of the optical path switching to change a connection of a terminal associated with switching of the optical path; and
transitioning the base station that is the source of the optical path switching to a sleep state after the optical path is switched and the connection of the terminal is changed.
